(19) United States
(12) Patent Application Publication
(10) Pub. No.: US 2025/0208531 A1
(43) Pub. Date: Jun. 26, 2025

(54) TONER

(71) Applicant: CANON KABUSHIKI KAISHA, Tokyo (JP)

(72) Inventors: KAZUYUKI SATO, Kanagawa (JP); KOSUKE FUKUDOME, Tokyo (JP); SHOHEI TSUDA, Shizuoka (JP); TORU ISHII, Shizuoka (JP); KENYA TERADA, Shizuoka (JP)

(21) Appl. No.: 18/990,953

(22) Filed: Dec. 20, 2024

(30) Foreign Application Priority Data
Dec. 26, 2023 (JP) 2023-219458
Dec. 2, 2024 (JP) 2024-209211

(51) Int. Cl. G03G 9/087

(52) U.S. Cl. CPC G03G 9/08755; G03G 9/08704

(57) ABSTRACT

A toner includes a toner particle containing a binder resin. The binder resin contains 50 mass % or more of polyester A, and the polyester A contains a unit Uᵢₛₒ derived from isophthalic acid in an amount of 60 mol % or more based on total units derived from acid components. The toner particle is a core-shell particle composed of a core portion and a shell portion, and the shell portion contains resin B including a monomer unit having a functional group selected from the group consisting of a salicylate functional group and a sulfonate group.

### BACKGROUND

### Technical Field

The present disclosure relates to a toner that is used in an image-forming method such as electrophotography.

### Description of the Related Art

Electrophotography technology is technology of forming an electrostatic latent image on a uniformly charged photosensitive member and visualizing image information using a charged toner and is utilized in apparatuses such as a copier and a printer. Recently, in order to correspond to various uses of copiers and printers, a reduction in the power consumption, elongation of the lifetime, and further acquisition of high quality images regardless of the environment are required.

Japanese Patent Laid-Open No. 2017-3851 discloses a toner containing an amorphous composite resin including an alkylene oxide adduct of bisphenol A, a polycondensation resin component obtained by polycondensation of an isophthalic acid compound and an aliphatic saturated carboxylic acid compound, and a styrenic resin component in order to obtain a toner having improved low-temperature fixability and exhibiting excellent gloss of printed matter. Since entanglement of polymer chains is less compared to when a terephthalic acid compound or the like is used as a raw material, the melt viscosity during fixing is reduced, and the gloss of printed matter can be improved.

Japanese Patent Laid-Open No. 2019-49629 discloses a toner in which the present state of the release agent in toner particles and the dynamic viscoelasticity of the toner particles are controlled and also the proportion of isophthalic acid to the whole polycarboxylic acids in a polyester as a binder resin is regulated, in order to suppress occurrence of offset on another recording medium when writing on the back surface of a recording medium with a fixed solid image. The compatibility between the binder resin and the release agent is improved by containing the isophthalic acid, and thereby the growth of the diameter of a release agent domain is suppressed, and offset caused by release agent cracking can be improved.

However, as the results of the investigation by the present inventors, although the toner described in Japanese Patent Laid-Open No. 2017-3851 has excellent low-temperature fixability and gives high gloss, in vertical thin-line images in which a large pressure is applied to the toner during transferring, transfer voids occurred in some cases.

The toner described in Japanese Patent Laid-Open No. 2019-49629 can suppress offset due to the high affinity of isophthalic acid to the release agent, but, as in the toner described in Japanese Patent Laid-Open No. 2017-3851, in vertical thin-line images in which a large pressure is applied to the toner during transferring, transfer voids occurred in some cases.

From these reasons, it is desired for a toner excellent in low-temperature fixability and gloss of printed matter and capable of suppressing transfer voids in vertical thin-line images.

### SUMMARY

The present disclosure provides a toner excellent in low-temperature fixability and gloss of printed matter and capable of suppressing transfer voids in vertical thin-line images.

The present disclosure relates to a toner including a toner particle containing a binder resin, wherein the binder resin contains 50 mass % or more of polyester A, and the polyester A contains a unit Uᵢₛₒ derived from isophthalic acid in an amount of 60 mol % or more based on the total units derived from acid components, and the toner particle is a core-shell particle composed of a core portion and a shell portion, and the shell portion contains resin B including a monomer unit having a functional group selected from the group consisting of a salicylate functional group and a sulfonate group.

Further features of the present disclosure will become apparent from the following description of exemplary embodiments.

### DESCRIPTION OF THE EMBODIMENTS

In the present disclosure, the expression of “XX or more and YY or less” or “XX to YY” expressing a numerical range means a numerical range including the lower and upper limits, unless otherwise specified. When numerical ranges are stated stepwisely, the upper and lower limits of each numerical range can be combined in any way. The term “monomer unit” refers to the reacted form of a monomer substance in a polymer.

### Characteristics of the Present Disclosure

In electrophotography, the transfer process is a process of transferring and attaching a toner image formed on a photosensitive member surface to a sheet, and in order to obtain a high quality image, it is important to transfer the toner image on the photosensitive member obtained in the processing process directly to the sheet without destroying it. It is known that the transfer process is highly affected by the using environment and the image pattern, and various adverse effects occur in images.

A toner excellent in low-temperature fixability and gloss of printed matter has a disadvantage of easily causing a transfer void, which is falling out of the center area of a vertical thin-line image, during a transfer process. The reason why only the center area of a vertical thin-line image is not transferred is because vertical thin lines with small toner area with respect to the overall long side are easily subjected to a strong pressure. Furthermore, although the toner at the image edge can be displaced to a non-image area direction, in the center area, the toner can be displaced. Accordingly, the pressure is further increased, and the adhesion force between a toner particle and a drum and between toner particles is increased to cause a transfer void. In order to solve the above disadvantage, the present inventors investigated toners with controlled viscoelasticity and chargeability.

However, even if the viscoelasticity and chargeability of a toner were controlled, a transfer void could not be sufficiently suppressed while having excellent low-temperature fixability and gloss of printed matter. It has been revealed by investigation by the present inventors that easiness of the plastic deformation of a toner is highly involved in an increase in the adhesion force and further that the structure of the monomer unit of a resin contained in the toner affects the adhesion force of the resin. In addition to the above, it was also noted that it is possible to expect to design suitable resin components for the respective toners by adopting a core-shell particle composed of a core portion and a shell portion as the toner particle.

Accordingly, the present inventors have further diligently investigated and as a result, have found that the above-mentioned disadvantage can be solved by combining a shell portion containing a resin including a monomer unit having a functional group selected from the group consisting of a salicylate functional group and a sulfonate group with a core portion containing a polyester derived from isophthalic acid.

The present inventors paid attention to isophthalic acid, which is a monomer unit of polyester. Isophthalic acid is an aromatic dicarboxylic acid having two carboxy groups at the meta-positions of a benzene ring, and easily forms a zigzag polymer structure, which suppresses interactions between polymer chains, to easily form a flexible structure, compared to terephthalic acid having two carboxy groups at the para-positions of a benzene ring. Therefore, excellent low-temperature fixability is obtained, and high gloss can also be obtained due to the less entanglement of molecular chains. At the same time, plastic deformation easily occurs when applied with a high pressure, and the adhesion force increases as the contact area increases. In addition, isophthalic acid becomes a polyester by condensation polymerization and has a wide polar surface due to alignment of the COO bonds of the two ester groups in the same direction with respect to the central benzene ring, and strong interactions between molecules take place to cause an increase in the adhesion force between a toner particle and a drum and between toner particles. For the above reasons, it was difficult to sufficiently suppress transfer voids in a toner excellent in low-temperature fixability and gloss of printed matter.

The present inventors attempted to increase the chargeability of a toner and increase the electrostatic force in order to improve the transferability, but could not suppress an increase in the adhesion force, and a sufficient effect for suppressing transfer voids was not observed. The present inventors diligently investigated and found that it is effective to combine a shell portion containing resin B including a monomer unit having a functional group selected from the group consisting of a salicylate functional group and a sulfonate group with a core portion containing a polyester.

That is, the present disclosure is a toner including a toner particle containing a binder resin, wherein the binder resin contains 50 mass % or more of polyester A, and the polyester A contains a unit Uᵢₛₒ derived from an isophthalic acid in an amount of 60 mol % or more based on the total units derived from acid components, and the toner particle is a core-shell particle composed of a core portion and a shell portion, and the shell portion contains resin B including a monomer unit having a functional group selected from the group consisting of a salicylate functional group and a sulfonate group.

With the above configuration, a disadvantage of transfer voids occurring in vertical thin-line images can be solved by a toner excellent in low-temperature fixability and gloss of printed matter. The reasons for this are explained below. The resin contained in the shell portion contains a monomer unit having a functional group selected from the group consisting of a salicylate functional group and a sulfonate group and thereby has charge-control ability, and can maintain the charge by being a resin. The electrostatic force as the transfer driving force can be increased by improving the chargeability of the toner. The core portion has a flexible structure and easily causes plastic deformation. Accordingly, the flexible core portion releases the pressure applied from the outside to the shell portion coating the core portion, and the elastic deformation suppresses an increase in the contact area to suppress an increase in the adhesion force between a toner particle and a drum and between toner particles. Furthermore, the strong interaction between molecules due to the wide polar surface derived from the ester group of isophthalic acid in the core portion is prevented by coating the shell portion, and an increase in the adhesion force between a toner particle and a drum and between toner particles can be suppressed.

As a result, it was demonstrated that a toner excellent in low-temperature fixability and gloss of printed matter can significantly improve transfer voids in vertical thin-line images.

Each component of the present disclosure will now be described in detail.

The toner of the present disclosure includes a toner particle containing a binder resin.

The binder resin contains 50 mass % or more of polyester A, and it is necessary that the polyester A contains 60 mol % or more of unit Uᵢₛₒ derived from isophthalic acid based on the total units derived from acid components [(Uᵢₛₒ/total acid component)×100 is 60 mol % or more)]. Consequently, not only the fixability is improved, but also the gloss of fixed image is improved. (Uᵢₛₒ/total acid component)×100 may be 90 mol % or more.

The polyester A of the present disclosure contains unit U_{EO} derived from the ethylene oxide adduct of bisphenol A and unit U_{PO} derived from the propylene oxide adduct of bisphenol A, and the total content proportion of the unit U_{EO} and the unit U_{PO} may be 90 mol % or more based on the total units derived from the alcohol component. The ethylene oxide adduct of bisphenol A and the propylene oxide adduct of bisphenol A have a benzene ring in the main chain and thereby improve the endurance of the toner to suppress transfer voids in vertical thin-line images over a long period of time.

The content proportion of the unit U_{EO} to the sum of the content proportion of the unit U_{EO} and the content proportion of the unit U_{PO}, [U_{EO}/(U_{EO}+U_{PO})]×100, may be 15 mol % or more and 40 mol % or less. The U_{PO} is a bisphenol A unit that has a larger number of carbon atoms compared to the U_{EO} and is adducted with a propylene oxide having a branch structure. When [U_{EO}/(U_{EO}+U_{PO})]×100 is 15 mol % or more, since the density of the benzene ring in the main chain increases, the endurance is improved. When [U_{EO}/(U_{EO}+U_{PO})]×100 is 40 mol % or less, since the density of hydrocarbon in the main chain increases, the low-temperature fixability is improved. For the above reasons, [U_{EO}/(U_{EO}+U_{PO})]×100 may be 15 mol % or more and 40 mol % or less.

When the number-average molecular weight (Mn) and the weight-average molecular weight (Mw) of the tetrahydrofuran (THF) soluble matter of polyester A of the present disclosure are measured by gel permeation chromatography (GPC), the number-average molecular weight (Mn) is 3,000 or more and 10,000 or less, and the Mw/Mn may be 2.5 or more.

The number-average molecular weight (Mn) may be 3,000 or more and 10,000 or less, because the change in melt flowability due to a pressure difference caused by the image pattern during fixing can be reduced, and gloss unevenness after low-temperature fixation can be suppressed. The number-average molecular weight (Mn) may be 4,000 or more and 8,000 or less.

An Mw/Mn of 2.5 or more means a sufficiently broad molecular weight distribution of polyester A, can reduce the change in melt flowability due to a pressure difference caused by the image pattern during fixing, and can suppress gloss unevenness after low-temperature fixation.

The binder resin of the present disclosure may further contain a crystalline polyester, because a good toner having excellent low-temperature fixability and capable of suppressing gloss unevenness after low-temperature fixation can be obtained. The content of the crystalline polyester in the binder resin may be 3.0 mass % or more and 30.0 mass % or less. Polyesters as the crystalline polyester will be described later.

The toner particle of the present disclosure may contain 0.015 mass % or more and 0.150 mass % or less of aluminum atoms because transfer voids in vertical thin-line images in a low-temperature and low-humidity environment can be further suppressed. When the amount of aluminum atoms is in the above-mentioned range, aluminum in the toner particle forms a crosslinked structure to provide elasticity in a low-temperature and low-humidity environment, plastic deformation under a high pressure is suppressed, and transfer voids in vertical thin-line images in a low-temperature and low-humidity environment can be suppressed.

The toner particle of the present disclosure may have an average circularity of 0.950 or more and 0.980 or less because transfer voids in vertical thin-line images can be further suppressed. Within the above range, the toner in a vertical thin-line image can be appropriately replaced in the non-image area direction, pressure concentration can be relieved, and thereby transfer voids can be further suppressed. The average circularity of the toner particle may be 0.955 or more and 0.975 or less.

On the other hand, the shell portion of the present disclosure contains resin B, the resin B includes a monomer unit having a functional group selected from the group consisting of a salicylate functional group and a sulfonate group.

The monomer having a salicylate functional group is at least one or more monomers selected from the group consisting of 3-vinylsalicylic acid, 4-vinylsalicylic acid, 5-vinylsalicylic acid, 6-vinylsalicylic acid, 3-vinyl-5-isopropylsalicylic acid, 3-vinyl-5-t-butylsalicylic acid, and 4-vinyl-6-t-butylsalicylic acid or a monomer represented by the following formula (I). In particular, the monomer may be a monomer represented by the following formula (I):

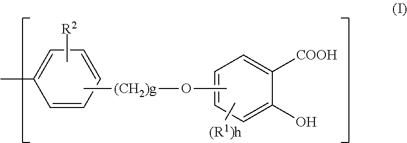

(in the formula, R¹s each independently represent a hydroxy group, a carboxy group, an alkyl group having 1 to 18 carbon atoms, or an alkoxy group having 1 to 18 carbon atoms, R² represents a hydrogen atom, a hydroxy group, an alkyl group having 1 to 18 carbon atoms, or an alkoxy group having 1 to 18 carbon atoms, g is an integer of 1 or more and 3 or less, and h is an integer of 0 or more and 3 or less).

Examples of the alkyl group as R¹ or R² include a methyl group, an ethyl group, a propyl group, an isopropyl group, a butyl group, an isobutyl group, an s-butyl group, and a t-butyl group, and examples of the alkoxy group include a methoxy group, an ethoxy group, and a propoxy group.

Examples of the monomer having a sulfonate group include styrenesulfonic acid, 2-acrylamide-2-methylpropanesulfonic acid (AMPS), vinylsulfonic acid, methacrylsulfonic acid, a maleimide derivative, and a styrene derivative, and a maleic acid amide derivative of the following formula (II). The monomer may have a partial structure derived from 2-acrylamide-2-methylpropanesulfonic acid.

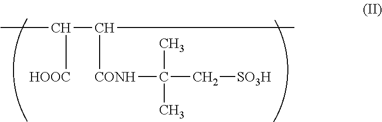

The resin B may be a vinyl resin. When the resin B is a vinyl resin, the water content of the resin can be reduced, and an increase in the adhesion force in a high-temperature and high-humidity environment can be suppressed. Consequently, transfer voids in vertical thin-line images in a high-temperature and high-humidity environment can be suppressed.

In the resin B, the content of the monomer unit having a functional group selected from the group consisting of a salicylate functional group and a sulfonate group may be 0.3 mass % or more and 10 mass % or less.

In the toner particle of the present disclosure, a peak P_{S} derived from the salicylate functional group of the resin B and a peak P_{A} derived from the carbonyl group of the polyester A are detected by ATR-IR analysis. The ratio of the intensity Is of the peak P_{S} to the intensity I_{A} of the peak P_{A}, I_{S}/I_{A}, may be in a range of 0.02 or more and 0.20 or less.

### Embodiment of Toner Particle

Components and embodiments of the toner particle of the present disclosure will now be described.

### Binder Resin

The toner particle of the present disclosure contains a binder resin. The content of the binder resin may be 50 mass % or more relative to the total amount of the resin components in the toner particle.

As described above, it is necessary that the binder resin contains 50 mass % or more of polyester A. When the content is 70 mass % or more, not only the fixability is improved, but also the gloss after fixation is improved.

The binder resin of the present disclosure may contain a polyester other than the polyester A, for example, a styrene acrylic resin, an epoxy resin, a polyester, a polyurethane resin, a polyamide, a cellulose resin, a polyether resin, or a mixture or composite resin thereof.

### Polyester A

As described above, it is necessary that the polyester A of the present disclosure contains 60 mol % or more, or 90 mol % or more, of unit Uᵢₛₒ derived from isophthalic acid based on the total units derived from acid components.

The polyester A that is included in the toner particle of the present disclosure may be an amorphous polyester.

As long as a unit derived from isophthalic acid is an essential component, examples of polyester A include the following polyesters.

The polyester is obtained by a known synthesis method such as transesterification or polycondensation for a combination of those selected from a polycarboxylic acid, a polyol, a hydroxycarboxylic acid, and so on. The polyester may include a condensation polymer of a dicarboxylic acid and a diol.

Polycarboxylic acid is a compound containing two or more carboxy groups in one molecule. Dicarboxylic acid is a compound containing two carboxy groups in one molecule and may be used as the polycarboxylic acid, and examples thereof include oxalic acid, succinic acid, glutaric acid, maleic acid, adipic acid, β-methyl adipic acid, azelaic acid, sebacic acid, nonanedicarboxylic acid, decanedicarboxylic acid, undecanedicarboxylic acid, dodecanedicarboxylic acid, fumaric acid, citraconic acid, diglycolic acid, cyclohexane-3,5-diene-1,2-carboxylic acid, hexahydroterephthalic acid, malonic acid, pimelic acid, suberic acid, phthalic acid, isophthalic acid, terephthalic acid, tetrachlorophthalic acid, chlorophthalic acid, nitrophthalic acid, p-carboxyphenylacetic acid, p-phenylenediacetic acid, m-phenylenediacetic acid, o-phenylenediacetic acid, diphenylacetic acid, diphenyl-p,p′-dicarboxylic acid, naphthalene-1,4-dicarboxylic acid, naphthalene-1,5-dicarboxylic acid, naphthalene-2,6-dicarboxylic acid, anthracene dicarboxylic acid, and cyclohexane dicarboxylic acid.

Examples of the multivalent carboxylic acid other than the above-mentioned dicarboxylic acids include trimellitic acid, trimesic acid, pyromellitic acid, naphthalenetricarboxylic acid, naphthalenetetracarboxylic acid, pyrenetricarboxylic acid, pyrenetetracarboxylic acid, itaconic acid, glutaconic acid, n-dodecylsuccinic acid, n-dodecenylsuccinic acid, isododecylsuccinic acid, isododecenylsuccinic acid, n-octylsuccinic acid, and n-octenylsuccinic acid. These multivalent carboxylic acids may be used alone or in combination of two or more thereof.

The polyol is a compound containing two or more hydroxy groups in one molecule. Diol is a compound containing two hydroxy groups in one molecule and may be used as the polyol, and examples thereof include ethylene glycol, diethylene glycol, triethylene glycol, 1,2-propanediol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, 1,14-eicosanedecanediol, dipropylene glycol, polyethylene glycol, polypropylene glycol, polytetramethylene ether glycol, 1,4-cyclohexanediol, 1,4-cyclohexanedimethanol, 1,4-butenediol, neopentyl glycol, polytetramethylene glycol, hydrogenated bisphenol A, bisphenol A, bisphenol F, bisphenol S, and alkylene oxide (ethylene oxide, propylene oxide, butylene oxide, or the like) adducts of the above bisphenols.

An alkylene glycol having 2 to 12 carbon atoms or an alkylene oxide adduct of a bisphenol may be used. An alkylene oxide adduct of a bisphenol or a combination thereof with an alkylene glycol having 2 to 12 carbon atoms may be used. Examples of the alkylene oxide adduct of bisphenol A include compounds represented by the following formula (A):

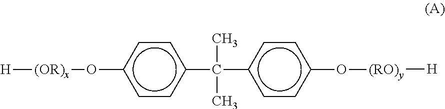

(in the formula (A), Rs are each independently an ethylene or propylene group, x and y are each an integer of 0 or more, and the average of (x+y) is 0 or more and 10 or less).

The alkylene oxide adduct of bisphenol A may be a propylene oxide adduct and/or ethylene oxide adduct of bisphenol A and may be a propylene oxide adduct of bisphenol A. The average of (x+y) may be 1 or more and 5 or less.

Examples of the tri- or higher valent alcohol include glycerin, trimethylolethane, trimethylolpropane, pentaerythritol, hexamethylolmelamine, hexaethylolmelamine, tetramethylolbenzoguanamine, tetraethylolbenzoguanamine, sorbitol, trisphenol PA, phenol novolac, cresol novolac, and alkylene oxide adducts of these tri- or higher valent polyphenols. These alcohols may be used alone or in combination of two or more thereof.

The acid value of the polyester A of the present disclosure may be 4.0 mg KOH/g or more and 10.0 mg KOH/g or less.

### Crystalline Polyester

The toner particle of the present disclosure may include a crystalline polyester. The crystalline polyester may be a condensation polymer of a monomer including an aliphatic diol and/or an aliphatic dicarboxylic acid. The crystalline polyester refers to a polyester having a clear melting point when measured using a differential scanning calorimeter (DSC).

The crystalline polyester may contain a monomer unit derived from an aliphatic diol having 2 to 12 (or 6 to 12) carbon atoms and/or an aliphatic dicarboxylic acid having 2 to 12 (or 6 to 12) carbon atoms.

The crystalline polyester having such a structure improves the dispersibility of the crystalline polyester between toner particles and can suppress unevenness in wet-spreading between toner particles during fixing. Therefore, the low-temperature fixability of half-tone images and line images is improved.

Examples pf the aliphatic diol having 2 to 12 carbon atoms include the following compounds: 1,2-ethanediol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, and 1,12-dodecanediol.

In addition, an aliphatic diol having a double bond can be used. Examples of the aliphatic diol having a double bond include the following compounds: 2-butene-1,4-diol, 3-hexene-1,6-diol, and 4-octene-1,8-diol.

Examples of the aliphatic dicarboxylic acid having 2 to 12 carbon atoms include the following compounds: oxalic acid, malonic acid, succinic acid, glutaric acid, adipic acid, pimelic acid, suberic acid, azelaic acid, sebacic acid, 1,9-nonanedicarboxylic acid, 1,10-decanedicarboxylic acid, 1,11-undecanedicarboxylic acid, and 1,12-dodecanedicarboxylic acid. Lower alkyl esters and acid anhydrides of these aliphatic dicarboxylic acids also can be used. Among them, sebacic acid, adipic acid, 1,10-decanedicarboxylic acid, or a lower alkyl ester or acid anhydride thereof may be used. These aliphatic dicarboxylic acids may be used alone or as a mixture of two or more thereof.

An aromatic dicarboxylic acid can also be used. Examples of the aromatic dicarboxylic acid include the following compounds: terephthalic acid, isophthalic acid, 2,6-naphthalenedicarboxylic acid, and 4,4′-biphenyldicarboxylic acid. Among them, terephthalic acid is easy to obtain and easily forms a polymer having a low melting temperature.

In addition, a dicarboxylic acid having a double bond can be used. A dicarboxylic acid having a double bond can crosslink the entire resin using the double bond and thereby can be used for suppressing hot offset during fixing.

Examples of the dicarboxylic acid include fumaric acid, maleic acid, 3-hexenedioic acid, and 3-octenedioic acid, and lower alkyl esters and acid anhydrides thereof. In particular, fumaric acid and maleic acid may be used.

The crystalline polyester may be manufactured by any method without being particularly limited, and can be manufactured by a general method for polymerizing a polyester by reacting a dicarboxylic acid component and a diol component. For example, the crystalline polyester can be manufactured using a direct polycondensation method or a transesterification method properly depending on the type of the monomer.

The peak temperature of the maximum endothermic peak of a crystalline polyester measured using a differential scanning calorimeter (DSC) may be 50.0° C. or more and 100.0° C. or less and may be 60.0° C. or more and 90.0° C. or less from the viewpoint of low-temperature fixability.

### Release Agent

The toner of the present disclosure may contain a release agent as needed for improving fixability. As the release agent, any known release agent can be used. Specifically, the release agent is, for example, a petroleum wax, such as a paraffin wax, a microcrystalline wax, and a petroleum wax, or a derivative thereof, a montan wax or its derivative, a hydrocarbon wax produced by a Fischer-Tropsch process or its derivative, a polyolefin wax represented by polyethylene and polypropylene or its derivative, a natural wax such as a carnauba wax and a candelilla wax or its derivative, or an ester wax. Here, the term “derivative” includes an oxide, a block copolymer with a vinyl monomer, and a graft modified product. As the ester wax, not only monofunctional and bifunctional ester waxes but also multifunctional, such as tetrafunctional and hexafunctional, ester waxes can be used.

The melting point of the release agent may be 60° C. or more and 140° C. or less or 70° C. or more and 130° C. or less. When the melting point is 60° C. or more and 140° C. or less, the toner is easily plasticized during fixing to improve the fixability. In addition, hot offset and so on of the release agent are unlikely caused even after long-term storage.

### Coloring Agent

In the toner of the present disclosure, examples of the coloring agent include an organic pigment, an organic dye, and an inorganic pigment, but the coloring agent is not particularly limited, and known coloring agents can be used.

Examples of the cyan coloring agent include a copper phthalocyanine compound and its derivative, an anthraquinone compound, and a basic dye lake compound, and specifically include the followings: C.I. Pigment Blue 1, C.I. Pigment Blue 7, C.I. Pigment Blue 15, C.I. Pigment Blue 15:1, C.I. Pigment Blue 15:2, C.I. Pigment Blue 15:3, C.I. Pigment Blue 15:4, C.I. Pigment Blue 60, C.I. Pigment Blue 62, and C.I. Pigment Blue 66.

Examples of the magenta coloring agent include the followings: a condensed azo compound, a diketopyrrolopyrrole compound, an anthraquinone compound, a quinacridone compound, a basic dye lake compound, a naphthol compound, a benzimidazolone compound, a thioindigo compound, and a perylene compound.

Specifically, the examples include the followings: C.I. Pigment Red 2, C.I. Pigment Red 3, C.I. Pigment Red 5, C.I. Pigment Red 6, C.I. Pigment Red 7, C.I. Pigment Violet 19, C.I. Pigment Red 23, C.I. Pigment Red 48:2, C.I. Pigment Red 48:3, C.I. Pigment Red 48:4, C.I. Pigment Red 57:1, C.I. Pigment Red 81:1, C.I. Pigment Red 122, C.I. Pigment Red 144, C.I. Pigment Red 146, C.I. Pigment Red 150, C.I. Pigment Red 166, C.I. Pigment Red 169, C.I. Pigment Red 177, C.I. Pigment Red 184, C.I. Pigment Red 185, C.I. Pigment Red 202, C.I. Pigment Red 206, C.I. Pigment Red 220, C.I. Pigment Red 221, and C.I. Pigment Red 254.

Examples of the yellow coloring agent include a condensed azo compound, an isoindolinone compound, an anthraquinone compound, an azo-metal complex, a methine compound, and an arylamide compound, and specifically include the followings: C.I. Pigment Yellow 12, C.I. Pigment Yellow 13, C.I. Pigment Yellow 14, C.I. Pigment Yellow 15, C.I. Pigment Yellow 17, C.I. Pigment Yellow 62, C.I. Pigment Yellow 74, C.I. Pigment Yellow 83, C.I. Pigment Yellow 93, C.I. Pigment Yellow 94, C.I. Pigment Yellow 95, C.I. Pigment Yellow 97, C.I. Pigment Yellow 109, C.I. Pigment Yellow 110, C.I. Pigment Yellow 111, C.I. Pigment Yellow 120, C.I. Pigment Yellow 127, C.I. Pigment Yellow 128, C.I. Pigment Yellow 129, C.I. Pigment Yellow 147, C.I. Pigment Yellow 151, C.I. Pigment Yellow 154, C.I. Pigment Yellow 155, C.I. Pigment Yellow 168, C.I. Pigment Yellow 174, C.I. Pigment Yellow 175, C.I. Pigment Yellow 176, C.I. Pigment Yellow 180, C.I. Pigment Yellow 181, C.I. Pigment Yellow 185, C.I. Pigment Yellow 191, and C.I. Pigment Yellow 194.

Examples of the black coloring agent include carbon black and those toned to black using the above-mentioned yellow coloring agents, magenta coloring agents, cyan coloring agents, and magnetic materials.

These coloring agents can be used alone, as a mixture, or in a state of solid solution. The coloring agent that is used in the present disclosure is selected from the viewpoints of hue angle, color saturation, lightness value, light fastness, OHP transparency, and dispersibility in a toner particle.

When a magnetic material is used as a coloring agent in the toner of the present disclosure, the magnetic material includes a magnetic iron oxide, such as magnetite and 7-iron oxide, as a main component and may contain an element such as phosphorus, cobalt, nickel, copper, magnesium, manganese, aluminum, and silicon. These magnetic materials may have a BET specific surface area by a nitrogen adsorption method of 2 m²/g or more and 30 m²/g or less, or 3 m²/g or more and 28 m²/g or less, and may have a Mohs' hardness of 5 or more and 7 or less. Examples of the shape of the magnetic material include a polyhedron, an octahedron, a hexahedron, a sphere, a spicule, and a flake, and a magnetic material with low anisotropic properties, such as polyhedron, an octahedron, a hexahedron, and a sphere, can enhance image density.

The amount of the coloring agent to be added may be 1 part by mass or more and 20 parts by mass or less based on 100 parts by mass of the binder resin or the polymerizable monomer constituting the binder resin. When a magnetic powder is used, the amount of the coloring agent may be 20 parts by mass or more and 200 parts by mass or less, or 40 parts by mass or more and 150 parts by mass or less, based on 100 parts by mass of the binder resin or the polymerizable monomer constituting the binder resin.

### External Additive

In the toner of the present disclosure, an inorganic external additive or the like may be mixed with toner particles and thereby adhere to the toner particle surface. Examples of the inorganic external additive include silica, strontium titanate, fatty acid metal salt, alumina, titanium oxide, a hydrotalcite compound, zinc oxide microparticles, and metal oxide microparticles (inorganic microparticles) of cerium oxide microparticles and calcium carbonate microparticles.

As the external additive, a composite oxide microparticle made of two or more metals can be used, or any combination of two or more selected from these microparticle groups can be used. A resin microparticle or an organic inorganic composite microparticle of a resin particle and an inorganic microparticle can also be used.

The external additive may be hydrophobically treated with a hydrophobic treatment agent. Examples of the hydrophobic treatment agent include chlorosilanes such as methyltrichlorosilane, dimethyldichlorosilane, trimethylchlorosilane, phenyltrichlorosilane, diphenyldichlorosilane, t-butyldimethylchlorosilane, and vinyltrichlorosilane; alkoxysilanes such as tetramethoxysilane, methyltrimethoxysilane, dimethyldimethoxysilane, phenyltrimethoxysilane, diphenyldimethoxysilane, o-methylphenyltrimethoxysilane, p-methylphenyltrimethoxysilane, n-butyltrimethoxysilane, i-butyltrimethoxysilane, hexyltrimethoxysilane, octyltrimethoxysilane, decyltrimethoxysilane, dodecyltrimethoxysilane, tetraethoxysilane, methyltriethoxysilane, dimethyldiethoxysilane, phenyltriethoxysilane, diphenyldiethoxysilane, i-butyltriethoxysilane, decyltriethoxysilane, vinyltriethoxysilane, γ-methacryloxypropyltrimethoxysilane, γ-glycidoxypropytrimethoxysilane, γ-glycidoxypropylmethyldimethoxysilane, γ-mercaptopropytrimethoxysilane, γ-chloropropyltrimethoxysilane, γ-aminopropyltrimethoxysilane, γ-aminopropyltriethoxysilane, γ-(2-aminoethyl)aminopropyltrimethoxysilane, and γ-(2-aminoethyl)aminopropylmethyldimethoxysilane; silazanes such as hexaethyldisilazane, hexapropyldisilazane, hexabutyldisilazane, hexapentyldisilazane, hexahexyldisilazane, hexacyclohexyldisilazane, hexaphenyldisilazane, divinyltetramethyldisilazane, and dimethyltetravinyldisilazane; silicone oils such as dimethyl silicone oil, methyl hydrogen silicone oil, methylphenyl silicone oil, alkyl-modified silicone oil, chloroalkyl-modified silicone oil, chlorophenyl-modified silicone oil, fatty acid-modified silicone oil, polyether-modified silicone oil, alkoxy-modified silicone oil, carbinol-modified silicone oil, amino-modified silicone oil, fluorine-modified silicone oil, and terminal reactive silicone oil; siloxanes such as hexamethylcyclotrisiloxane, octamethylcyclotetrasiloxane, decamethylcyclopentasiloxane, hexamethyldisiloxane, and octamethyltrisiloxane; and fatty acid and its metal salt such as long chain fatty acids, such as undecylic acid, lauric acid, tridecylic acid, dodecylic acid, myristic acid. palmitic acid, pentadecylic acid, stearic acid, heptadecylic acid, arachidic acid, montanic acid, oleic acid, linoleic acid, and arachidic acid, and salts of the above fatty acids and metals such as zinc, iron, magnesium, aluminum, calcium, sodium, and lithium.

Among these hydrophobic treatment agents, alkoxysilanes, silazanes, silicone oils may be used because of easiness of hydrophobic treatment. These hydrophobic treatment agents may be used alone or in combination of two or more thereof.

The content of the external additive may be 0.05 parts by mass or more and 20.0 parts by mass or less based on 100 parts by mass of the toner particle.

### Others

The toner of the present disclosure may have a glass transition temperature (Tg) of 40° C. or more and 70° C. or less. A toner having a glass transition temperature of 40° C. or more and 70° C. or less can improve the storage stability and endurance while maintaining good fixability.

The toner may have a weight-average particle diameter (D4) of 3.0 μm or more and 12.0 μm or less, or 4.5 μm or more and 7.5 μm or less. When the weight-average particle diameter (D4) is 3.0 μm or more and 12.0 μm or less, a good flowability is obtained, and the latent image can be developed faithfully.

### Method for Manufacturing Toner

The method for manufacturing the toner is not particularly limited, and a known manufacturing method can be adopted. Examples of the toner-manufacturing method include a kneading pulverization method and a wet manufacturing method. The method may be a wet manufacturing method from the viewpoint of easily obtaining a core-shell particle structure, uniformizing the particle diameter, and controlling the shape. Examples of the wet manufacturing method include a suspension polymerization method, a dissolution suspension method, an emulsion polymerization aggregation method, and an emulsion aggregation method, and an emulsion aggregation method may be used. That is, the method for manufacturing the toner particles may include a step of aggregating microparticles of the binder resin to form aggregated particles and a step of fusing the aggregated particles to obtain toner particles. The toner particles may be emulsion-aggregated toner particles. This is because a core-shell particle can be easily produced by coating the core portion aggregated in an aqueous medium by a desired shell portion.

The method for manufacturing a toner particle by an emulsion aggregation method will be described in detail below as an example.

### Dispersion-Preparing Process

A binder resin particle dispersion is prepared by, for example, as follows. When the binder resin is a homopolymer or copolymer (vinyl resin) of a vinyl monomer, a vinyl monomer is emulsion-polymerized or seed-polymerized in an ionic surfactant to prepare a dispersion in which particles of a vinyl resin are dispersed in an ionic surfactant. When the binder resin is a resin other than a vinyl resin, such as a polyester, the resin is mixed with an aqueous medium in which an ionic surfactant and a polymer electrolyte are dissolved.

Subsequently, this solution is heated to the melting point or softening point of the resin for dissolution, and a dispersion in which binder resin particles are dispersed in an ionic surfactant is prepared using a disperser with a strong shearing force, such as a homogenizer.

The means for dispersion is not particularly limited, and examples thereof include dispersing devices known per se, such as a rotary shearing homogenizer, a ball mill using a medium, a sand mill, and Dinomill.

As the method for preparing a dispersion, a phase inversion emulsification method may be used. The phase inversion emulsification method is a method for obtaining an emulsion by dissolving a binder resin in an organic solvent, adding a neutralizer and a dispersion stabilizer thereto as needed, dropwise adding an aqueous solvent thereto while stirring to obtain emulsified particles, and then removing the organic solvent in the resin dispersion. On this occasion, the order of adding the neutralizer and the dispersion stabilizer may be changed. The number-average particle diameter of the binder resin particle is usually 1 μm or less and may be 0.01 μm or more and 1.00 μm or less. When the number-average particle diameter is 1.00 μm or less, the finally obtained toner exhibits a good particle diameter distribution, and occurrence of free particles can be suppressed. When the number-average particle diameter is within the above range, uneven distribution between toners is reduced, dispersion in toners is improved, and variations in performance and reliability are reduced.

The resin particle (resin B particle) containing a monomer unit selected from the group consisting of a salicylate functional group and a sulfonate group for producing the shell portion may have a number-average particle diameter of 0.01 μm or more and 0.50 μm or less, or 0.02 μm or more and 0.50 μm or less. Within the above range, core-shell particles coated with a thin film can be easily obtained.

The emulsion aggregation method can use a coloring agent particle dispersion as needed. The coloring agent particle dispersion is a dispersion in which at least a coloring agent particle is dispersed in a dispersing agent. The number-average particle diameter of the coloring agent particles may be 0.5 μm or less or 0.2 μm or less. When the number-average particle diameter is 0.5 μm or less, diffused reflection of visible light can be prevented, and the binder resin particles and the coloring agent particles are easily aggregated in the aggregation step. When the number-average particle diameter is within the above range, uneven distribution between toners is reduced, dispersion in toners is improved, and variations in performance and reliability are reduced.

The emulsion aggregation method can use a wax particle dispersion as needed. A wax particle dispersion is a dispersion in which at least wax particles are dispersed in a dispersing agent. The wax particles may have a number-average particle diameter of 2.0 μm or less or 1.0 μm or less. When the number-average particle diameter is 2.0 μm or less, the deviation in the content of the wax between toner particles is small, and stability of images over a long period of time is improved. When the number-average particle diameter is within the above range, uneven distribution between toners is reduced, dispersion in toners is improved, and variations in performance and reliability are reduced.

The combination of a coloring agent particle, a binder resin particle, and a wax particle is not particularly limited and can be appropriately selected freely depending on the purpose. In addition to the above dispersions, another particle dispersion in which a particle appropriately selected is dispersed in a dispersing agent may be further mixed. The particle included in such another particle dispersion is not particularly limited and can be appropriately selected depending on the purpose, and Examples thereof include an internal additive particles, charge control agent particles, inorganic particles, and polishing material particles. These particles may be dispersed in a binder resin particle dispersion or a coloring agent particle dispersion.

Examples of the dispersing agent included in the binder resin particle dispersion, coloring agent particle dispersion, wax microdispersion, and another particle dispersion include aqueous media containing polar surfactants. Examples of the aqueous medium include water such as distilled water and deionized water and alcohols. These media may be used alone or in combination of two or more thereof. The content of the polar surfactant cannot be generally defined and can be appropriately selected depending on the purpose.

Examples of the polar surfactant include anionic surfactants such as sulfate, sulfonate, phosphate, and soap surfactants; and cationic surfactants such as amine and quaternary ammonium surfactants. Specific examples of the anionic surfactant include sodium dodecylbenzenesulfonate, sodium tetradecylbenzenesulfonate, sodium dodecylsulfate, sodium alkylnaphthalenesulfonate, and sodium dialkylsulfosuccinate. Specific examples of the cationic surfactant include alkylbenzenedimethylammonium chloride, alkyltrimethylammonium chloride, and distearylammonium chloride. These surfactants may be used alone or in combination of two or more thereof.

Transfer voids in vertical thin-line images in a high-temperature and high-humidity environment can be suppressed by using sodium alkylbenzenesulfonate with C12-14 alkyl group as the polar surfactant. Sodium dodecylbenzenesulfonate may be used.

These polar surfactants may be used in combination with a nonpolar surfactant. Examples of the nonpolar surfactant include polyethylene glycol, alkylphenol ethylene oxide adduct, and polyvalent alcohol nonionic surfactants.

The content of the coloring agent particle may be 0.1 parts by mass or more and 30 parts by mass or less based on 100 parts by mass of the binder resin in the aggregated particle dispersion when the aggregated particles are formed.

The content of the wax particle may be 0.5 parts by mass or more and 25 parts by mass or less, or 5 parts by mass or more and 20 parts by mass or less, based on 100 parts by mass of the binder resin in the aggregated particle dispersion when the aggregated particles are formed.

Furthermore, in order to more control the chargeability of the obtained toner, the charge controlling particle and the binder resin particle may be added after formation of aggregated particles.

The particle sizes of particles such as the binder resin particle and the coloring agent particle are measured using a laser diffraction and scattering particle size distribution measuring apparatus LA-960V2 manufactured by HORIBA, Ltd.

### Aggregation Step

The aggregation step of forming aggregated particles is a step of forming aggregated particles including a binder resin particle and as needed, a coloring agent particle, a wax particle, and so on in an aqueous medium containing the binder resin particle and as needed, the coloring agent particle, the wax particle, and so on.

The aggregated particles can be formed in an aqueous medium by adding, for example, a flocculant, a pH adjuster, and a stabilizer to the aqueous medium, mixing them, and appropriately applying temperature, mechanical power, and so on thereto.

Examples of the flocculant include monovalent metal salts such as sodium and potassium; divalent metal salts such as calcium and magnesium; trivalent metal salts such as iron and aluminum; and alcohols such as methanol, ethanol, and propanol. The flocculant containing di- or higher valent metal element has a high flocculation power and can cause aggregation by a small amount of addition.

Specifically, the examples include, but not limited to, divalent inorganic metal salts, such as calcium chloride, calcium nitrate, magnesium chloride, magnesium sulfate, and zinc chloride; trivalent metal salts, such as ion(III) chloride, iron(III) sulfate, aluminum sulfate, and aluminum chloride; and inorganic metal salt polymers, such as polyaluminum chloride, polyaluminum hydroxide, polyferric sulfate, and polycalcium sulfide. These flocculants may be used alone or in combination of two or more thereof. From the viewpoint of controlling the amount of aluminum element in the toner particle, an aluminum metal salt may be used.

Examples of the pH adjuster include alkalis such as ammonia and sodium hydroxide and acids such as nitric acid and citric acid.

The stabilizer mainly includes a polar surfactant itself and an aqueous medium containing it. For example, when the polar surfactant included in each particle dispersion is anionic, a cationic stabilizer can be selected as the stabilizer.

The flocculant and so on may be added in the form of either a dry powder or an aqueous solution dissolved in an aqueous medium, and in order to cause uniform aggregation, they may be added in the form of an aqueous solution.

The addition and mixing of the flocculant and so on may be performed at a temperature of the glass transition temperature of less of the resin included in the aqueous medium. When mixing is performed in this temperature condition, aggregation progresses in a stable state. The mixing can be performed, for example, a mixing device, homogenizer, or mixer known per se.

In the aggregation step, a dispersion including a polyester is applied to the surface of the aggregated particle to form a shell portion, and thereby a toner particle having a core-shell structure in which a shell portion is formed on the surface of a core portion can be obtained. The aggregation step may be repeated in multiple stages.

### Fusion Step

The fusion step is a step of heating the obtained aggregated particles for melt-adhesion. Before the fusion step, in order to prevent melt-adhesion between toner particles, a pH adjuster, a polar surfactant, a nonpolar surfactant, and the like can be appropriately added. The temperature of heating may be from the glass transition temperature of the resin included in the aggregated particles (in two or more resins, the glass transition temperature of the resin with the highest glass transition temperature) to the decomposition temperature of the resin. Accordingly, the heating temperature varies depending on the type of the resin of the binder resin particle and cannot be generally defined, but is generally the glass transition temperature of the resin included in the aggregated particles or more to 140° C. or less. The heating can be performed using a heating device or equipment known per se.

Regarding the time for melt-adhesion, when the heating temperature is high, a shorter time is sufficient, and when the heating temperature is low, a longer time is required. That is, the time for fusion depends on the heating temperature and therefore cannot be generally defined, but is generally 30 minutes or more and 10 hours or less.

The toner particles obtained through each of the above steps are collected by solid-liquid separation according to a known method and subsequently can be washed and dried under appropriate conditions.

### External Addition Step

A toner can be obtained by adding an external additive such as an inorganic external additive to the obtained toner particles. The mixing time in the external addition step may be adjusted in a range of 0.5 minutes or more and 10.0 minutes or less from the viewpoint of the dispersibility of the external additive and may be adjusted in a range of 1.0 minutes or more and 5.0 minutes or less.

### Method for Measuring Each Physical Property

Methods for measuring each physical property will now be described.

### Method for Isolating Toner Particles

A dispersion medium is prepared by adding Triton X-100 (0.50 g, manufactured by Kishida Chemical Co., Ltd.) to deionized water (100 g).
(1) A toner (1.00 g) is precisely weighed in a vial bottle, and the dispersion medium (10.00 g) is added thereto to make up to 10.00 g, followed by leaving to stand for 24 hours to prepare a sample solution.
(2) The sample solution is subjected to ultrasonic wave homogenizer treatment, and the external additive is separated from the toner and is dispersed in a dispersion medium:
Ultrasonication apparatus: ultrasonic homogenizer VP-050 (manufactured by Taitec Corporation);
Microchip: step-type microchip, front edge diameter: 2 mm;
Front edge position of microchip: the center area of glass vial, and a height of 5 mm from the vial bottom; and
Ultrasonic wave conditions: an intensity of 30% for 180 minutes. On this occasion, the vial is ultrasonicated while cooling the vial with iced water so that the temperature of the dispersion does not rise.
(3) Toner particles in the sample solution are separated from the dispersion medium (filtrate) in which the external additive is dispersed by suction filtration (10 μm membrane filter).
(4) The toner particles after filtration are collected, and a dispersion medium is added thereto again to make up to 10.00 g, and then toner particles obtained by repeating the (2) and (3) a total of 10 times are collected and sufficiently dried at 45° C. for 24 hours. Thus, toner particles are isolated.
   Method for Isolating Binder Resin from Toner Particle

Toner particles (100 mg) are dissolved in chloroform (3 mL). Subsequently, suction filtration with a syringe attached with a sample treatment filter (pore size: 0.2 μm or more and 0.5 μm or less, for example, Maishori-Disk H-25-2 (manufactured by Tosoh Corporation)) to remove insoluble matter. The soluble matter is introduced to preparative HPLC (apparatus: manufactured by Japan Analytical Industry Co., Ltd., LC-9130 NEXT preparation column [60 cm], exclusion limit: 20,000 and 70,000, connected two columns), and a chloroform eluent is sent thereto. When peaks are observed on the obtained chromatographic display, the fraction corresponding to the retention time at which the molecular weight of a monodisperse polystyrene standard specimen is 2,000 or more is collected. The solution of obtained fraction is dried and solidified, and thereby the binder resin is separated from the release agent and is collected.

### Composition Analysis of Binder Resin Composed of Multiple Components

The chloroform-soluble matter of the collected binder resin is used as a specimen. The specimen is adjusted such that the concentration of the toner particle is 0.1 mass % by chloroform, and the solution is filtered through a 0.45 μm PTFE filter and is then subjected to measurement. The gradient polymer LC measurement conditions are shown below:
Apparatus: UlTIMATE 3000 (manufactured by Thermo Fisher Scientific);
Mobile phase: A: chloroform (HPLC), B: acetonitrile (HPLC);
Gradient: 2 min (A/B=0/100)→25 min (A/B=100/0) (the gradient of change in the mobile phase is made linear);
Flow rate: 1.0 mL/min;
Injection: 0.1 mass %×20 μL;
Column: Tosoh TSKgel ODS (4.6 mmφ×150 mm×5 μm);
Column temperature: 40° C.; and
Detector: Corona charged particle detector (Corona-CAD) (manufactured by Thermo Fisher Scientific).

In the time-intensity graph obtained by measurement, a peak corresponding to a high-polar component, i.e., resin A and a peak corresponding to a low-polar component, i.e., resin B are observed. When a resin other than the resin A and resin B is contained, a peak corresponding to its polarity is observed. Subsequently, the measurement is performed again, and resin A, resin B, and other resins can be separated by collecting fractions at the time when each peak reaches its valley.

When the toner contains a release agent, it is necessary to separate the release agent from the toner. In the separation of the release agent, components with a molecular weight of 2,000 or less are separated as the release agent by recycle HPLC. The measurement method will be shown below. First, a chloroform solution of the toner is produced by the above-described method. The obtained solution is filtered through a solvent resistant membrane filter with a pore diameter of 0.2 μm “Maishori-Disk” (manufactured by Tosoh Corporation) to obtain a sample solution. The sample solution is adjusted such that the concentration of the components soluble in chloroform is 1.0 mass %. This sample solution is used for measurement under the following conditions:
Apparatus: LC-Sakura NEXT (manufactured by Japan Analytical Industry Co., Ltd.);
Column: JAIGEL 2H and 4H (manufactured by Japan Analytical Industry Co., Ltd.);
Eluent: chloroform;
Flow rate: 10.0 mL/min;
Oven temperature: 40.0° C.; and
Specimen injection amount: 1.0 mL.

In calculation of the molecular weight of a specimen, a molecular weight calibration curve produced using a standard polystyrene resin (for example, tradename “TSK Standard Polystyrene F-850, F-450, F-288, F-128, F-80, F-40, F-20, F-10, F-4, F-2, F-1, A-5000, A-2500, A-1000, and A-500”, manufactured by Tosoh Corporation) is used. Components having a molecular weight of 2,000 or less are repeatedly collected based on the thus-obtained molecular weight curve to remove the release agent from the toner. In the collection, a required amount of the chloroform/acetonitrile solution is harvested for each fraction, dried, and concentrated to obtain each sample of polyester A (resin A) and crystalline polyester (resin D).

The composition ratio and mass ratio by nuclear magnetic resonance spectrometry (NMR) are measured using the samples of the resin A component and the resin D component as follow.

Deuterated chloroform (1 mL) is added to the sample (20 mg) of each of the resin A component and the resin D component, and the NMR spectra of protons of the dissolved resins are measured. The molar ratio and the mass ratio of each monomer are calculated from the obtained NMR spectra, and the content proportion of each monomer unit can be determined. For example, in a styrene-acrylic copolymer, the composition ratio and the mass ratio can be calculated based on a peak at around 6.5 ppm derived from the styrene monomer and a peak at around 3.5 to 4.0 ppm derived from an acrylic monomer.

The nuclear magnetic resonance spectrometry (NMR) can use the following apparatus and measurement conditions:
NMR apparatus: manufactured by JEOL Ltd., RESONANCE ECX500;
Observation nuclear: proton; and
Measurement mode: single pulse.
   Method for Quantitatively Measuring Uᵢₛₒ, U_{EO}, and U_{PO} in Polyester A by NMR

Identification of components of polyester A and measurement of molar ratio and mass ratio thereof are performed by nuclear magnetic resonance spectrometry (NMR) as follows.

Deuterated chloroform (1 mL) is added to the obtained polyester A (20 mg), and the NMR spectrum of protons of the dissolved polyester A is measured. The molar ratio and mass ratio of each monomer are calculated from the obtained NMR spectrum by regarding the minimum unit sandwiched between ester bonds as a structure derived from a monomer.

For example, the composition ratio and the mass ratio can be calculated based on the following peaks (the chemical shift value and the number of protons):
Unit derived from isophthalic acid: 7.5 ppm (1), 8.2 ppm (2), and 8.7 ppm (1);
Unit derived from terephthalic acid: 8.1 ppm (4);
Unit derived from ethylene oxide adduct of bisphenol A: 1.6 ppm (δ), 4.3 ppm (4), 4.7 ppm (4), 6.8 ppm (4), and 7.1 ppm (4);
Unit derived from propylene oxide adduct of bisphenol A: 1.5 ppm (δ), 1.6 ppm (δ), 4.1 ppm (4), 5.5 ppm (2), 6.8 ppm (4), and 7.1 ppm (4);
Unit derived from ethylene glycol: 4.3 ppm (4);
NMR apparatus: JEOL RESONANCE ECX500;
Observation nuclear: proton;
Measurement mode: single pulse; and
Base peak: TMS.

The content (mol %) of the unit Uᵢₛₒ derived from isophthalic acid based on the total units derived from acid components is determined by the NMR analysis. In addition, the total content proportion (mol %) of the U_{EO} and the U_{PO} based on the total units derived from the alcohol component is determined. Then, the content proportion (mol %) of the U_{EO} to the sum of the content proportion of the U_{EO} and the content proportion of the U_{PO} is determined.

### Identification of Monomer Unit of Resin by Pyrolysis Gas Chromatography Mass Spectrometry (Pyrolysis GC/MS)

The monomer unit of a resin included in toner particles is identified by pyrolysis gas chromatography mass spectrometry (pyrolysis GC/MS).
Pyrolysis apparatus: manufactured by Japan Analytical Industry Co., Ltd., TPS-700;
Thermal decomposition temperature: proper value within 400° C. to 600° C., in this case, 590° C.;
GC/MS apparatus: manufactured by Thermo Fisher Scientific, ISQ; and
Column: “HP5-MS” (Agilent/19091S-433), length: 30 m, inner diameter: 0.25 mm, film thickness: 0.25 μm,
GC/MS Condition:
Inlet condition: InletTemp: 250° C., SplitFlow: 50 mL/min;
GC temperature rise condition: 40° C. (5 min)→10° C./min (300° C.)→300° C. (20 min); and
Mass range: m/z=10 to 550.

The peak inherent to the monomer unit having a salicylate functional group or sulfonate group included in the resin B is selected as follows.

In the case of resin B-1 in Example, peaks of m/z=153 (corresponding to a portion including salicylic acid) and 253 (corresponding to a monomer unit including salicylic acid) are selected.

In the case of resin B-2 in Example, a peak of m/z=163 (corresponding to a monomer unit including salicylic acid) is selected.

In the case of resin B-3 in Example, peaks of m/z=80 (corresponding to SO₃⁻) and 206 (corresponding to a monomer unit including sulfonic acid) are selected.

Peaks of m/z=76, 120, and 121 (corresponding to isophthalic acid and terephthalic acid portions) and 211 (corresponding to bisphenol A portion) derived from dicarboxylic acid or diol of polyesters included in the resin A are selected.

### Identification of Monomer Unit of Resin Included in Shell of Toner Particle

Identification and mapping of a monomer unit of the resin included in the shell of a toner particle are analyzed using a time-of-flight secondary ion mass spectrometry (TOF-SIMS). In the measurement of the ion amount (peak intensity) using a TOF-SIMS, nanoTOFII manufactured by Ulvac-Phi, Inc. is used. The analysis conditions are as follows:
Sample preparation: the toner particles separated from a toner are attached to an indium sheet by the above-described method;
Sample pre-treatment: none;
Primary ion: Bi₃⁺⁺ ion;
Accelerating voltage: 30 kV;
Charge neutralization mode: On;
Measurement mode: Negative;
Raster: 300×300 m²;
Mass range: m/z=0.5 to 1850; and
Measurement time: 30 seconds.

In also TOF-SIMS, a peak inherent to the monomer unit is selected by the pyrolysis GC/MS and mapped to analyze whether a shell is present or not and to analyze the monomer unit having a salicylate functional group or a sulfonate group included in the shell.

### Method for Measuring Weight-Average Molecular Weight Mw and Number-Average Molecular Weight Mn

The molecular weights of the specimens such as polyester A, crystalline polyester, and styrene acryl are measured by gel permeation chromatography (GPC) as follows.

First, a specimen is dissolved in tetrahydrofuran (THF). In the cases of polyester A and styrene acryl, they are dissolved in THF at room temperature over 24 hours. In the case of crystalline polyester, THF is heated to 40° C., and the crystalline polyester is dissolved therein and is then left to stand for 24 hours.

Each of the solutions of the specimens is filtered through a solvent resistant membrane filter with a pore diameter of 0.2 μm “Maishori-Disk” (manufactured by Tosoh Corporation) to obtain each sample solution. The sample solution is adjusted such that the concentration of the component soluble in THF is 0.8 mass %. The sample solutions are used for measurement under the following conditions:
Apparatus: HLC8120GPC (detector: RI) (manufactured by Tosoh Corporation);
Column: connected seven columns, Shodex KF-801, 802, 803, 804, 805, 806, and 807 (manufactured by Resonac Corporation):
Eluent: tetrahydrofuran (THF);
Flow rate: 1.0 mL/min;
Oven temperature: 40.0° C.; and
Specimen injection amount: 0.10 mL.

In calculation of the molecular weight of a specimen, a molecular weight calibration curve produced using a standard polystyrene resin (for example, tradename “TSK Standard Polystyrene F-850, F-450, F-288, F-128, F-80, F-40, F-20, F-10, F-4, F-2, F-1, A-5000, A-2500, A-1000, and A-500”, manufactured by Tosoh Corporation) is used.

### Method for Quantitatively Measuring Aluminum Element in Toner Particle

X-ray fluorescence of aluminum element is measured according to JIS K 0119-1969, specifically, as follows.

As the measurement apparatus, a wavelength dispersion X-ray fluorescence analysis apparatus “Axios” (manufactured by PANalytical) and provided dedicated software “SuperQ ver. 4.0F” (manufactured by PANalytical) for setting measurement conditions and analyzing measurement data are used. Rh is used as the anode of the X-ray tube, the measurement atmosphere is vacuum, the measurement diameter (collimator mask diameter) is 27 mm, and measurement time is 10 seconds. Detection uses a proportional counter (PC).

As a measurement sample, a palette with a thickness of about 2 mm and a diameter of about 39 mm formed by putting about 4 g of a toner particle into a dedicated aluminum ring for pressing and flattening it and then pressing it at 20 MPa for 60 seconds using a tablet molding compressor “BRE-32” (manufactured by Maekawa Testing Machine Mfg. Co., Ltd.) is used.

Measurement is performed by setting accelerating voltage and current value of an X-ray generator to 24 kV and 160 mA, respectively, each element is identified based on the obtained peak position of X-ray, and the concentration thereof is calculated from the counting rate (unit: cps) that is the number of X-ray photons per unit time. Toner FT-IR spectral measurement (calculation of I_{S} and I_{A})

FT-IR spectral measurement of a toner is performed by an ATR method using a Fourie transform infrared spectral analysis apparatus (tradename: Spectrum One, manufactured PerkinElmer, Inc.) equipped with a universal ATR sampling accessory. Specific measurement procedure and method for calculating I_{S} and I_{A} are as follows.

The incident angle of infrared light (k=5 μm) is set to 45°. As the ATR crystal, ATR crystal of germanium (refractive index=4.0) is used. Other conditions are as follows.

### Range:

Start: 4,000 cm⁻¹;
End: 600 cm⁻¹ (ATR crystal of Ge); and
400 cm⁻¹ (ATR crystal of diamond),

### Duration:

Scan number: 16;
Resolution: 4.00 cm⁻¹; and
Advanced: CO₂/H₂O with correction.
(1) ATR crystal of Ge (refractive index=4.0) is attached to the apparatus.
(2) Background is measured by setting Scan type to Background and setting Units to EGY.
(3) Scan type is set to Sample, and Units is set to A.
(4) 0.01 g of a toner is precisely weighed on the ATR crystal.
(5) The sample is pressed with a pressure arm (force gauge is 100).
(6) The sample is subjected to measurement.
(7) The obtained FT-IR spectrum is subjected to base line correction by Automatic Correction.
(8) From the spectrum after correction, “I_{S}” that is the peak intensity of the maximum absorption peak P_{S} in a range of 1658 cm⁻¹ or more and 1678 cm⁻¹ or less is calculated, and “I_{A}” that is the peak intensity of the maximum absorption peak P_{A} in a range of 1714 cm⁻¹ or more 1734 cm⁻¹ or less is calculated.

### Method for Measuring Melting Point

The melting points of specimens such as crystalline polyester, release agent, and plasticizer are measured using a differential scanning calorimeter (DSC) Q2000 (manufactured by TA Instruments) under the following conditions:
Temperature-raising rate: 10° C./min;
Measurement starting temperature: 20° C.; and
Measurement ending temperature: 180° C.

The temperature correction of the detecting unit of the apparatus uses melting points of indium and zinc, and the amount of heat is corrected using the heat of fusion of indium. Specifically, about 5 mg of a specimen is correctly weighed, put in an aluminum pan, and subjected to measurement once. As a reference, an empty aluminum pan is used. The peak temperature of the maximum endothermic peak at that time is defined as the melting point.

### Measurement of Glass Transition Temperature Tg

The glass transition temperature Tg is measured using a differential scanning calorimeter “Q2000” (manufactured by TA Instruments) according to ASTM D3418-82. The temperature correction of the detecting unit of the apparatus uses melting points of indium and zinc, and the amount of heat is corrected using the heat of fusion of indium. Specifically, about 2 mg of a specimen is correctly weighed, put in an aluminum pan, and subjected to measurement at a temperature-raising rate of 10° C./min in a measurement temperature range of from −10° C. to 200° C. using an empty aluminum pan as a reference. In the measurement, the temperature is increased up to 200° C. once, subsequently decreased down to −10° C., and then increased again. In this second temperature-increasing process, a specific heat change is obtained in a temperature range of from 30° C. to 100° C. The intersection point between the line at the midpoint of the baselines before and after the specific heat change occurs and the differential heat curve is defined as the glass transition temperature Tg.

### Measurement of Acid Value

The acid value is the number of milligrams of potassium hydroxide required for neutralizing the acid included in 1 g of a specimen. The acid value in the present disclosure is measured according to JIS K 0070-1992 and is specifically measured according to the following procedure.

Titration is performed using a 0.1 mol/L potassium hydroxide ethyl alcohol solution (manufactured by Kishida Chemical Co., Ltd.). The factor of the potassium hydroxide ethyl alcohol solution can be determined using a potentiometric titrator (manufactured by Kyoto Electronics Manufacturing Co., Ltd., potentiometric titrator AT-510). A 0.100 mol/L hydrochloric acid (100 mL) is placed in a 250-mL tall beaker and is titrated with the potassium hydroxide ethyl alcohol solution, and the acid value is determined from the amount of the potassium hydroxide ethyl alcohol solution required for neutralization. The 0.100 mol/L hydrochloric acid used is produced according to JIS K 8001-1998.

The measurement conditions for the acid value measurement are shown below.
Titrator: potentiometric titrator AT-510 (manufactured by Kyoto Electronics Manufacturing Co., Ltd.);
Electrode: composite glass electrode double junction type (manufactured by Kyoto Electronics Manufacturing Co., Ltd.);
Titrator control software: AT-WIN; and
Titration analysis software: Tview.

Titration parameters and control parameters during titration are as follows.

### Titration Parameters:

Titration mode: blank titration;
Titration mode: total volume titration;
Maximum titration volume: 20 mL;
Waiting time before titration: 30 seconds; and
Titration direction: automatic,

### Control Parameters:

End point judgement potential: 30 dE;
End point judgement potential value: 50 dE/dmL;
End point detection judgement: not set;
Control speed mode: standard;
Gain: 1;
Data collection potential: 4 mV;
Data collection titration volume: 0.1 mL;
Main test: A measurement sample (0.100 g) is precisely weighed in a 250-mL tall beaker, a solution mixture (150 mL) of toluene/ethanol (3:1) is added thereto, followed by dissolving over 1 hour. Titration is performed with the potentiometric titrator above using the potassium hydroxide ethyl alcohol solution; and
Blank test: Titration is performed by the same procedure as above except that no specimen is used (that is, only a solution mixture of toluene/ethanol (3:1) is used). The acid value is calculated by substituting the obtained result into the following expression:

A=[(C−B)×f×5.611]/S

(in the expression, A: acid value (mg KOH/g), B: volume (mL) of potassium hydroxide ethyl alcohol solution in the blank test, C: volume (mL) of potassium hydroxide ethyl alcohol solution in the main test, f: factor of potassium hydroxide solution, and S: specimen (g)).

### Method for Measuring Average Circularity of Toner (Particles)

The average circularity of a toner or toner particles is measured using a flow type particle image analyzer “FPIA-3000” (manufactured by Sysmex Corporation) under the measurement and analysis conditions for calibration.

An appropriate amount of an alkyl benzene sulfonate that is a surfactant is added as a dispersing agent to 20 mL of deionized water, then 0.02 g of a measurement specimen is added thereto, and dispersion treatment is performed using a tabletop ultrasonic cleaner/disperser of an oscillating frequency of 50 kHz and an electrical output of 150 watts (tradename: VS-150, manufactured by Velvo-Clear) for 2 minutes to prepare a dispersion for measurement. On this occasion, the dispersion is appropriately cooled to a temperature of 10° C. or more and 40° C. or less.

The measurement uses the flow type particle image analyzer equipped with a standard objective lens (10×) and a particle sheath “PSE-900A” (manufactured by Sysmex Corporation) as the sheath liquid. A dispersion prepared according to the above procedure is introduced into the flow type particle image analyzer, and 3,000 particles of a toner are counted by the total counter mode in the HPF measurement mode, and the average circularity of the toner (particles) is determined by limiting the binarization threshold during particle analysis to 85% and the circle-equivalent diameter of the analyzed particle diameter to 1.98 μm or more and 19.92 μm or less.

In the measurement, automatic focus adjustment is performed before the start of the measurement using a standard latex particle (for example, 5100A (tradename) manufactured by Duke Scientific Corporation diluted with deionized water). Subsequently, focus adjustment may be carried out every 2 hours from the start of the measurement.

### Measurement of Weight-Average Particle Diameter (D4) and Number-Average Particle Diameter (D1) of Toner (Particles)

The weight-average particle diameter (D4) and number-average particle diameter (D1) of a toner (particles) are calculated by analyzing the measurement data obtained by an aperture impedance method using a precise particle size distribution measuring apparatus “Coulter Counter Multisizer 3” (registered trademark, manufactured by Beckman Coulter, Inc.) provided with an aperture tube of 100 μm and attached dedicated software “Beckman Coulter Multisizer 3, Version 3.51” (manufactured Beckman Coulter, Inc.) for setting measurement conditions and measurement data analysis at a number of effective measuring channels of 25,000.

As the electrolytic aqueous solution to be used for the measurement, special grade sodium chloride dissolved in deionized water in a concentration of about 1 mass %, for example, “ISOTON II” (manufactured by Beckman Coulter, Inc.), can be used.

Before the measurement and analysis, the dedicated software is set to as follows.

On the “Change Standard Measurement Method (SOM) Screen” of the dedicated software, the total counts in control mode is set to 50,000 particles, the number of measurement is set to 1, and the Kd value is set to the value obtained using “Standard Particle 10.0 μm” (manufactured by Beckman Coulter, Inc.). The threshold and noise level are automatically set by pressing the threshold/noise level measurement button. The current is set to 1600 μA, the gain is set to 2, and the electrolytic solution is set to ISOTON II, and the flash of aperture tube after measurement is checked.

On the “Pulse to Particle Diameter Conversion Setting Screen” of the dedicated software, the bin interval is set to logarithmic particle diameter, the particle diameter bin is set to a 256 particle diameter bin, and the particle diameter range is set to 2 μm or more and 60 μm or less.

The specific measurement method is as follows.
(1) About 200 mL of the electrolytic aqueous solution is placed in a 250-mL round-bottomed glass beaker exclusively provided for Multisizer 3, the beaker is set on a sample stand, and a stirrer rod is stirred counterclockwise at 24 revolution/sec. The dirt and air bubbles inside the aperture tube are removed by the “Flush Aperture” function of the dedicated software.
(2) About 30 mL of the electrolytic aqueous solution is placed in a 100-mL flat-bottomed glass beaker, and about 0.3 mL of a solution of “Contaminon N” (a 10 mass % aqueous solution of a neutral detergent consisting of a nonionic surfactant, an anionic surfactant, and an organic builder and having a pH of 7 for washing precision measuring instruments, manufactured by FUJIFILM Wako Pure Chemical Corporation) diluted 3-fold by mass with deionized water is added as a dispersing agent thereto.
(3) A predetermined amount of deionized water is placed in a water tank of an ultrasonic disperser “Ultrasonic Dispersion System Tetora 150” (manufactured by Nikkaki Bios) having an electrical output of 120 W and including two oscillators with an oscillating frequency of 50 kHz that are built in with a phase shift of 180 degrees, and about 2 mL of the Contaminon N is added to the water tank.
(4) The beaker in the above (2) is set in the beaker fixing hole of the ultrasonic disperser, and the ultrasonic disperser is operated. The height position of the beaker is adjusted so that the resonance state of the liquid level of the electrolytic aqueous solution in the beaker is maximized.
(5) While the electrolytic aqueous solution in the beaker in the above (4) is being irradiated with ultrasonic waves, about 10 mg of a toner (particles) is added little by little to the electrolytic aqueous solution and dispersed. The ultrasonic dispersion treatment is continued for another 60 seconds. In the ultrasonic dispersion, the temperature of water in the water tank is appropriately adjusted to 10° C. or more and 40° C. or less.
(6) The electrolytic aqueous solution in the above (5) in which the toner (particles) is dispersed is dropwise added using a pipette to the round-bottomed beaker in the above (1) installed in the sample stand, and the measurement concentration is adjusted to about 5%. The measurement is continued until the number of measured particles reaches 50,000.
(7) The measurement data are analyzed with the dedicated software attached to the apparatus, and the weight-average particle diameter (D4) is calculated. The weight-average particle diameter (D4) is the “average diameter” on the analysis/volume statistics (arithmetic mean) screen when graph/vol % is set using the dedicated software, and the number-average particle diameter (D1) is the “average diameter” on the “analysis/number statistics (arithmetic mean)” screen when graph/number % is set using the dedicated software.

### EXAMPLES

Although the present disclosure will now be described more specifically by Production Examples and Examples, these are not intended to limit the present disclosure in any way. All parts in the following compositions are parts by mass.

### Production Example 1 of Polyester A

Bisphenol A ethylene oxide 2 mole adduct: 25 parts by mole;
Bisphenol A propylene oxide 2 mole adduct: 75 parts by mole; and
Isophthalic acid: 100 parts by mole.

The above monomers were charged in a flask equipped with a stirrer, a nitrogen inlet tube, a temperature sensor, and a rectifying column, and it was confirmed that the reaction system was being stirred uniformly when heated to 190° C. over 1 hour. Tin distearate (1.0 parts) was added to these monomers (100 parts). The temperature was further increased from 190° C. to 250° C. over 5 hours while distilling the generated water, and dehydration condensation was further carried out at 250° C. for 2 hours.

As a result, polyester A-1 having a glass transition temperature of 60.4° C., an acid value of 11 mg KOH/g, a hydroxyl value of 24 mg KOH/g, an Mn of 8,000, and an Mw/Mn of 3.5 was obtained.

### Production Examples 2 to 14 of Polyester A

Polyesters A-2 to A-14 were obtained as in Production Example 1 of polyester A except that the monomers in Production Example 1 of polyester A were changed as shown in Table 1 and that the reaction temperature and dehydration condensation were changed such that the obtained polyester A has desired Mn and Mw/Mn values. The results are shown in Table 1.

TABLE 1

| | | Polyester | Polyester | Polyester | Polyester | Polyester | Polyester | Polyester |
|---|---|---|---|---|---|---|---|---|
| | | A-1 | A-2 | A-3 | A-4 | A-5 | A-6 | A-7 |
| Acid | Isophthalic acid | 100 | 100 | 90 | 85 | 60 | 90 | 90 |
| component | (parts by mole) | | | | | | | |
| | Terephthalic acid | 0 | 0 | 10 | 15 | 40 | 10 | 10 |
| | (parts by mole) | | | | | | | |
| Alcohol | BPA-EO | 25 | 25 | 25 | 25 | 25 | 23 | 21 |
| component | (parts by mole) | | | | | | | |
| | BPA-PO | 75 | 75 | 75 | 75 | 75 | 67 | 64 |
| | (parts by mole) | | | | | | | |
| | Ethylene glycol | 0 | 0 | 0 | 0 | 0 | 10 | 15 |
| | (parts by mole) | | | | | | | |
| Mn | | 8000 | 4300 | 9000 | 9200 | 9800 | 8200 | 6000 |
| Mw/Mn | | 3.5 | 4.2 | 3.2 | 3.4 | 3.6 | 3.0 | 2.8 |
| Uᵢₛₒ proportion in acid | | 100 | 100 | 90 | 85 | 60 | 90 | 90 |
| component (mol %) | | | | | | | | |
| Total proportion of U_{EO} and | | 100 | 100 | 100 | 100 | 100 | 90 | 85 |
| U_{PO} in Alcohol component | | | | | | | | |
| (mol %) | | | | | | | | |
| Proportion of U_{EO} to | | 25.0 | 25.0 | 25.0 | 25.0 | 25.0 | 25.6 | 24.7 |
| total of U_{PO} and | | | | | | | | |
| U_{EO} (mol %) | | | | | | | | |
| | | Polyester | Polyester | Polyester | Polyester | Polyester | Polyester | Polyester |
| | | A-8 | A-9 | A-10 | A-11 | A-12 | A-13 | A-14 |
| Acid | Isophthalic acid | 90 | 90 | 90 | 90 | 90 | 0 | 55 |
| component | (parts by mole) | | | | | | | |
| | Terephthalic acid | 10 | 10 | 10 | 10 | 10 | 100 | 45 |
| | (parts by mole) | | | | | | | |
| Alcohol | BPA-EO | 20 | 14 | 36 | 12 | 38 | 25 | 25 |
| component | (parts by mole) | | | | | | | |
| | BPA-PO | 60 | 76 | 54 | 78 | 52 | 75 | 75 |
| | (parts by mole) | | | | | | | |
| | Ethylene glycol | 20 | 10 | 10 | 10 | 10 | 0 | 0 |
| | (parts by mole) | | | | | | | |
| Mn | | 3200 | 9400 | 4600 | 10600 | 2800 | 8900 | 8500 |
| Mw/Mn | | 2.6 | 3.3 | 2.8 | 3.4 | 2.3 | 3.2 | 3.4 |
| Uᵢₛₒ proportion in acid | | 90 | 90 | 90 | 90 | 90 | 0 | 55 |
| component (mol %) | | | | | | | | |
| Total proportion of U_{EO} and | | 80 | 90 | 90 | 90 | 90 | 100 | 100 |
| U_{PO} in alcohol | | | | | | | | |
| component (mol %) | | | | | | | | |
| Proportion of U_{EO} to the | | 25.0 | 15.6 | 40.0 | 13.3 | 42.2 | 25.0 | 25.0 |
| total of U_{PO} and | | | | | | | | |
| U_{EO} (mol %) | | | | | | | | |

### Production Example of Resin B-1

2,4-Dihydroxybenzoic acid (18 parts) was dissolved in methanol (150 parts), and potassium carbonate (36.9 parts) was added thereto, followed by heating to 65° C. To this reaction solution, a solution mixture of 4-(chloromethyl)styrene (18.7 parts) and methanol (100 parts) was dropwise added, followed by reaction at 65° C. for 3 hours. The reaction solution was cooled and then filtered, and the filtrate was concentrated to obtain a crude product. The crude product was dispersed in water (1,500 parts) with a pH of 2, and ethyl acetate was added thereto for extraction. Subsequently, washing with water, drying with magnesium sulfate, and distillation of ethyl acetate under reduced pressure were performed to obtain a precipitate. The precipitate was washed with hexane and was then purified by recrystallization with toluene and ethyl acetate to obtain a vinyl monomer represented by the following formula (1):

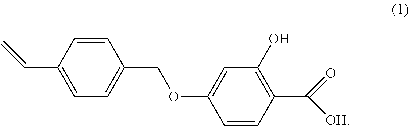 [SMILES: C=Cc1ccc(COc2ccc(C(=O)O)c(O)c2)cc1]

Subsequently, the vinyl monomer (13.1 parts) shown in the formula (1) and styrene (81.9 parts) were dissolved in toluene (42.0 parts), and the mixture was stirred for 1 hour and then heated to 110° C. To this reaction solution, a solution mixture of tert-butylperoxyisopropyl monocarbonate (3.0 parts, manufactured by NOF Corporation, tradename: Perbutyl I) and toluene (42 parts) was dropwise added, followed by further reaction at 110° C. for 4 hours. Subsequently, the reaction solution was dropwise added to cooled methanol (1,000 parts) to obtain a precipitate. The obtained precipitate was dissolved in THF (120 parts), the resulting solution was dropwise added to methanol (1,800 parts) to precipitate a white precipitate, and filtration and then drying at 90° C. under reduced pressure were performed to obtain resin B-1 that is a copolymer of styrene and a vinyl monomer represented by the formula (1). The physical properties are shown Table 2.

### Production Example of Resin B-2

Resin B-2 was obtained as in Production Example of resin B-1 except that the monomer to be used was changed to 4-vinylsalicylic acid (7.9 parts) while controlling the molecular weight by adjusting the polymerization temperature and the polymerization time. The physical properties are shown in Table 2.

### Production Example of Resin B-3

Pure water (1,000 parts) and sodium dodecylsulfate (4 parts) as an emulsifying agent were charged in a 3-L flask equipped with a stirrer, a capacitor, a thermometer, and a nitrogen inlet tube, and nitrogen substitution was performed for 30 minutes. Potassium peroxydisulfate (KPS, 2 parts) was added thereto, followed by stirring and dissolving. The content was heated to 80° C. under nitrogen introduction. At the time when reached 80° C., a monomer mixture of styrene (300 parts) and 2-ethylhexyl acrylate (2-EHA, 60 parts) and an aqueous solution in which 2-acrylamide-2-methylpropane sulfonate (AMPS, 40 parts) was dissolved in pure water (600 parts) were separately dropwise added thereto over 2 hours. Subsequently, while maintaining 80° C., polymerization was performed for 8 hours to obtain an emulsion solution. The emulsion solution was dried at 50° C. with a vacuum dryer until the moisture content decreased to 1% or less to obtain resin B-3 that is a styrene/2-EHA/AMPS copolymer. The physical properties are shown in Table 2.

TABLE 2

| | Resin B-1 | Resin B-2 | Resin B-3 |
|---|---|---|---|
| Functional group | Salicylate | Salicylate | Sulfonate |
| | functional | functional | group |
| | group | group | |
| Acid value (mg KOH/g) | 27.2 | 26.5 | 21.6 |
| Number-average molecular weight | 29800 | 25500 | 18300 |
| Mn | | | |

### Production Example of Styrene Acrylic Resin C

Styrene: 77 parts;
Butyl acrylate: 23 parts; and
Di-t-butyl peroxide: 1.0 parts.

Xylene (200 parts by mass) was heated to 200° C., the above components were each dropwise added to the xylene over 4 hours, and the mixture was further retained for 1 hour under xylene reflux to complete polymerization.

As a result, styrene acrylic resin C with an Mn of 12,000 and an Mw/Mn of 5.9 was obtained.

### Production Example of Crystalline Polyester D-1

In a reaction tank equipped with a nitrogen inlet tube, a dehydration tube, a stirrer, and thermocouples,
1,10-decanedicarboxylic acid: 100 parts by mole;
1,9-nonanediol: 100 parts by mole; and
tin dioctylate as a catalyst: 0.8 parts with respect to the total mass of acid alcohol, the above materials were placed in a heat-dried two-neck flask and were heated while maintaining an inert atmosphere by introducing a nitrogen gas into the container and stirring. Subsequently, stirring was continued at 170° C. for 6 hours. Subsequently, while continuing stirring, the temperature was gradually increased to 230° C. under reduced pressure, and the temperature was maintained for further 3 hours. When a viscous state was obtained, cooling was performed to stop the reaction to obtain crystalline polyester D-1. The resulting physical properties are shown in Table 3.

### Production Examples of Crystalline Polyesters D-2 and D-3

Crystalline polyesters D-2 and D-3 were obtained as in Production Example of crystalline polyester D-1 except that the alcohol monomer and acid monomer used were changed as shown in Table 3.

The physical properties of crystalline polyesters D-2 and D-3 are shown in Table 3.

TABLE 3

| | Crystalline | Crystalline | Crystalline |
|---|---|---|---|
| | Polyester D-1 | Polyester D-2 | Polyester D-3 |
| Alcohol monomer | 1,9-Nonanediol | 1,12- | 1,12- |
| | | Dodecanediol | Dodecanediol |
| Acid monomer | 1,10- | Sebacic acid | Adipic acid |
| | Decanedicarboxylic | | |
| | acid | | |
| Acid value | 2 | 3 | 4 |
| (mg KOH/g) | | | |
| Melting point | 70 | 80 | 74 |
| (° C.) | | | |
| Mn | 11000 | 10000 | 14000 |
| Mw/Mn | 2.1 | 2.1 | 2.3 |

### Preparation of Resin Particle Dispersion of Polyester A-1

Polyester A-1: 100 parts;
Methyl ethyl ketone: 50 parts; and
Isopropyl alcohol: 20 parts.

The above methyl ethyl ketone and isopropyl alcohol were added in a container. Subsequently, the polyester A-1 was gradually added thereto, followed by stirring to completely dissolve and to obtain a polyester A-1 solution. The container containing this polyester A-1 solution was set to 65° C., a 10% ammonia aqueous solution was gradually dropwise added thereto in a total of 5 parts while stirring, and further deionized water (230 parts) was gradually dropwise added thereto at a rate of 10 mL/min for phase inversion emulsification. Furthermore, the solvent was removed by pressure reduction with an evaporator to obtain a resin particle dispersion of polyester A-1. The resin particle included in this resin particle dispersion had a volume-average particle diameter of 130 nm. The resin particle solid content was adjusted to 20% with deionized water.

### Preparation of Resin Particle Dispersion of Resin B-1

Resin B-1: 100 parts;
Methyl ethyl ketone; 50 parts, and
Isopropyl alcohol: 20 parts.

The above methyl ethyl ketone and isopropyl alcohol were added in a container. Subsequently, the resin B-1 was gradually added thereto, followed by stirring to completely dissolve and to obtain a resin B-1 solution. The container containing this resin B-1 solution was set to 65° C., a 10% ammonia aqueous solution was gradually dropwise added thereto in a total of 5 parts while stirring, and further deionized water (230 parts) was gradually dropwise added thereto at a rate of 30 mL/min for phase inversion emulsification. Furthermore, the solvent was removed by pressure reduction with an evaporator to obtain a resin particle dispersion of resin B-1. The resin particle included in this resin particle dispersion had a volume-average particle diameter of 40 nm. The resin particle solid content was adjusted to 20% with deionized water.

### Preparation of Resin Particle Dispersion of Styrene Acrylic Resin C

Styrene acrylic resin C: 100 parts;
Methyl ethyl ketone: 50 parts; and
Isopropyl alcohol: 20 parts.

The above methyl ethyl ketone and isopropyl alcohol were added in a container. Subsequently, the styrene acrylic resin C was gradually added thereto, followed by stirring to completely dissolve and to obtain a styrene acrylic resin C solution. The container containing this styrene acrylic resin C solution was set to 65° C., a 10% ammonia aqueous solution was gradually dropwise added thereto in a total of 5 parts while stirring, and further deionized water (230 parts) was gradually dropwise added thereto at a rate of 30 mL/min for phase inversion emulsification. Furthermore, the solvent was removed by pressure reduction with an evaporator to obtain a resin particle dispersion of styrene acrylic resin C. The resin particle included in this resin particle dispersion had a volume-average particle diameter of 110 nm. The resin particle solid content was adjusted to 20% with deionized water.

### Preparation of Resin Particle Dispersion of Crystalline Polyester D-1

Crystalline polyester D-1: 100 parts;
Methyl ethyl ketone: 50 parts; and
Isopropyl alcohol: 20 parts.

The above methyl ethyl ketone and isopropyl alcohol were added in a container. Subsequently, the crystalline polyester D-1 was gradually added thereto, followed by stirring to completely dissolve and to obtain a crystalline polyester D-1 solution. The container containing this crystalline polyester D-1 solution was set to 40° C., a 10% ammonia aqueous solution was gradually dropwise added thereto in a total of 3.5 parts while stirring, and further deionized water (230 parts) was gradually dropwise added thereto at a rate of 10 mL/min for phase inversion emulsification. Furthermore, the solvent was removed by pressure reduction to obtain a resin particle dispersion of crystalline polyester D-1. The resin particle included in this resin particle dispersion had a volume-average particle diameter of 150 nm. The resin particle solid content was adjusted to 20% with deionized water.

### Preparation of Coloring Agent Particle Dispersion 1

Copper phthalocyanine (Pigment Blue 15:3): 45 parts;
Sodium dodecylbenzenesulfonate: 5 parts; and
Deionized water: 190 parts.

The above components were mixed, were dispersed with a homogenizer (manufactured by IKA-Werke, Ultra Turrax) for 10 minutes, and were then subjected to dispersion treatment using Altimizer (counter-collision type wet pulverizer, manufactured by Sugino Machine Limited) at a pressure of 250 MPa for 20 minutes to obtain coloring agent particle dispersion 1 in which the coloring agent particle had a volume-average particle diameter of 120 nm and the solid content was 20%.

### Preparation of Coloring Agent Particle Dispersion 2

Coloring agent particle dispersion 2 was prepared as in the coloring agent particle dispersion 1 except that the sodium dodecylbenzenesulfonate was changed to sodium tetradecylbenzenesulfonate. In the coloring agent particle dispersion 2, the coloring agent particle had a volume-average particle diameter of 100 nm and the solid content was 20%.

### Preparation of Release Agent Particle Dispersion 1

Release agent (hydrocarbon wax, melting point: 79° C.): 15 parts;
Sodium dodecylbenzenesulfonate: 2 parts; and
Deionized water: 240 parts.

The above components were heated to 100° C. and sufficiently dispersed with Ultra Turrax T50 manufactured by IKA-Werke, and dispersion treatment was then performed by heating to 115° C. with a pressure discharge type Gaulin homogenizer for 1 hour to obtain release agent particle dispersion 1 in which the release agent particle had a volume-average particle diameter of 160 nm and the solid content was 20%.

### Preparation of Release Agent Particle Dispersion 2

Release agent particle dispersion 2 was prepared as in the release agent particle dispersion 1 except that sodium dodecylbenzenesulfonate was changed to sodium tetradecylbenzenesulfonate. In the release agent particle dispersion 2, the release agent particle had a volume-average particle diameter of 160 nm and the solid content was 20%.

### Production of Toner Particle 1

Resin particle dispersion of polyester A-1: 880 parts;
Resin particle dispersion of crystalline polyester D-1: 100 parts;
Coloring agent particle dispersion 1; 50 parts; and
Release agent particle dispersion 1: 80 parts.

The above materials were put in a round stainless steel flask and were mixed. Subsequently, dispersion was performed using a homogenizer Ultra Turrax T50 (manufactured by IKA-Werke) at 5,000 r/min for 10 minutes. A 1 mol/L sodium hydroxide aqueous solution was added thereto to adjust the pH to 8.0, and then an aqueous solution in which aluminum chloride (0.50 parts) as a flocculant was dissolved in deionized water (20 parts) was added thereto at 30° C. over 10 minutes while stirring. After leaving for 3 minutes, heating was started to raise the temperature to 50° C. to generate core particles.

The volume-average particle diameter of the formed aggregated particles was appropriately verified using a Coulter Multisizer 3, and when aggregated particles of 6.0 μm were formed, a resin particle dispersion (20 parts) of resin B-1 having a monomer unit was further added thereto in order to form a shell portion, followed by heating to 60° C. The temperature was maintained for 30 minutes, and sodium chloride (2.0 parts) was added thereto to stop the aggregation step.

Subsequently, as a spheronization step, the pH was adjusted to 9.0 by addition of a 1 mol/L sodium hydroxide aqueous solution, followed by heating to 92° C. while continuing stirring.

The heating was stopped when a desired surface profile was obtained, and as a cooling step, ice was promptly added such that the cooling rate of 10° C./sec or more was given to cool to 40° C., and further as an annealing step, annealing treatment was performed at 55° C. for 3 hours.

Subsequently, cooling to 25° C. and filtration/solid-liquid separation were performed, followed by washing with deionized water. After completion of the washing, drying was performed using a vacuum dryer to obtain toner particle 1 having a weight-average particle diameter (D4) of 7.1 m. The physical properties of the toner particle 1 are shown in Table 4.

### Production Examples of Toner Particles 2 to 5, 7 to 26, 29, and 30

Toner particles 2 to 5, 7 to 26, 29, and 30 were obtained as in Production Example of toner particle 1 except that the composition of the materials used and the manufacturing conditions were changed to achieve the prescriptions and physical properties shown in Table 4. The physical properties of the obtained toner particles 2 to 5, 7 to 26, 29, and 30 are shown in Tables 4-1 to 4-3.

### Production Examples of Toner Particles 6 and 28

In the generation of core particles of Production Example of toner particle 1, toner particles 6 and 28 were obtained by using a resin particle dispersion of styrene acrylic resin C and changing the prescription to those shown in Table 4. The physical properties of the toner particles 6 and 28 are shown in Tables 4-1 and 4-2.

### Production Example of Toner Particle 27

Toner particle 27 was obtained as in Production Example of toner particle 1 except that in the shell portion formation, a resin particle dispersion of styrene acrylic resin C was used instead of the resin particle dispersion of resin B-1 including a monomer unit and that the prescription was changed to that shown in Table 4. The physical properties of toner particle 27 are shown in Table 4-3.

### Production Example of Toner Particle 31

The materials below were well mixed with an FM mixer (manufactured by Nippon Coke & Engineering Co., Ltd.) and were then melted and kneaded with a twin-screw kneader (manufactured by Ikegai Corp.) set to a temperature of 100° C.
Polyester A-1: 95.0 parts;
Resin B-1 having monomer unit: 2.0 parts;
Crystalline polyester D-1: 3.0 parts;
Hydrocarbon wax (melting point: 79° C.): 8.0 parts; and
C.I. Pigment Blue 15:3: 5.0 parts.

The obtained kneaded product was cooled and roughly pulverized to 1 mm or less with a hammer mill to obtain a roughly pulverized product.

Subsequently, the obtained roughly pulverized product was pulverized into a finely pulverized product of about 6.5 μm using a turbo mill manufactured by Freund-Turbo Corporation, and then fine and coarse particles were further removed using a multi-division classifier that utilizes the Coanda effect to obtain toner particle 31.

The toner particle 31 had a weight-average particle diameter (D4) of 7.4 m, a Tg of 59.2° C., and an average circularity of 0.934. The physical properties are shown in Table 4-3.

### Production Example of Toner 1

External addition was carried out on the toner particle 1. The external addition was carried out by adding 20.0 g of hydrophobic silica microparticle (number-average particle diameter of primary particle: 7 nm) surface treated with dimethyl silicone oil to 2.0 kg of toner particle 1 using an FM mixer (manufactured by Nippon Coke & Engineering Co., Ltd., FM10), and then mixing them at 3,000 rpm for 5 minutes. On this occasion, the flow rate and temperature of the cold water flowing in the cooling jacket were controlled such that the temperature inside the tank after 5 minutes of mixing was 35° C.

Subsequently, the toner was sieved with mesh having an opening of 75 m to obtain toner 1. The physical properties of toner 1 are shown in Table 4.

### Production Examples of Toners 2 to 31

Toners 2 to 31 were obtained as in Production Example of toner 1 except that the type of the toner particle in Production Example of toner 1 was changed. The physical properties of the obtained toners 2 to 31 are shown in Table 4.

TABLE 4

| Toner particle No. | 1 | 2 | 3 | 4 | 5 | 6 |
|---|---|---|---|---|---|---|
| PES A | A-1 | A-2 | A-3 | A-4 | A-5 | A-1 |
| Volume-average particle diameter | 130 | 120 | 130 | 120 | 140 | 130 |
| of resin particle (PES A) (nm) | | | | | | |
| Resin B | B-1 | B-2 | B-1 | B-1 | B-1 | B-1 |
| Volume-average particle diameter | 40 | 40 | 40 | 40 | 20 | 30 |
| of resin particle (Resin B) (nm) | | | | | | |
| St-Ac resin C | — | — | — | — | — | Present |
| Volume-average particle diameter | — | — | — | — | — | 110 |
| of resin particle (St-Ac resin C) (nm) | | | | | | |
| Crystalline Polyester D | D-1 | D-1 | D-1 | D-1 | D-1 | D-1 |
| Volume-average particle diameter | 150 | 150 | 150 | 150 | 150 | 150 |
| of resin particle (C-PES D) (nm) | | | | | | |
| Coloring agent particle dispersion | 1 | 1 | 1 | 1 | 1 | 1 |
| Release agent particle dispersion | 1 | 1 | 1 | 1 | 1 | 1 |
| Toner manufacturing | Emulsion | Emulsion | Emulsion | Emulsion | Emulsion | Emulsion |
| method | aggregation | aggregation | aggregation | aggregation | aggregation | aggregation |
| Parts of PES A | 88 | 88 | 88 | 88 | 88 | 50 |
| Parts of resin B | 2 | 2 | 2 | 2 | 2 | 2 |
| Parts of St-Ac resin C | 0 | 0 | 0 | 0 | 0 | 38 |
| Parts of C-PES D | 10 | 10 | 10 | 10 | 10 | 10 |
| Content proportion of PES A in | 88 | 88 | 88 | 88 | 88 | 50 |
| binder resin (mass %) | | | | | | |
| Presence or absence of shell | Present | Present | Present | Present | Present | Present |
| Weight-average particle diameter | 6.6 | 6.6 | 6.6 | 6.8 | 6.9 | 6.8 |
| of toner particle (μm) | | | | | | |
| Al element content proportion | 0.032 | 0.032 | 0.034 | 0.037 | 0.037 | 0.045 |
| of toner particle (mass %) | | | | | | |
| Average circularity of | 0.956 | 0.956 | 0.957 | 0.957 | 0.957 | 0.957 |
| toner particle | | | | | | |
| Peak ratio I_{S}/I_{A} | 0.05 | 0.05 | 0.05 | 0.04 | 0.04 | 0.08 |
| in ATR-IR | | | | | | |

| Toner particle No. | 7 | 8 | 9 | 10 | 11 |
|---|---|---|---|---|---|
| PES A | A-1 | A-1 | A-1 | A-1 | A-1 |
| Volume-average particle diameter | 130 | 130 | 130 | 130 | 130 |
| of resin particle (PES A) (nm) | | | | | |
| Resin B | B-1 | B-1 | B-1 | B-1 | B-3 |
| Volume-average particle diameter | 480 | 300 | 20 | 10 | 40 |
| of resin particle (Resin B) (nm) | | | | | |
| St-Ac resin C | — | — | — | — | — |
| Volume-average particle diameter | — | — | — | — | — |
| of resin particle (St-Ac resin C) (nm) | | | | | |
| Crystalline Polyester D | D-1 | D-1 | D-1 | D-1 | D-1 |
| Volume-average particle diameter | 150 | 150 | 150 | 150 | 150 |
| of resin particle (C-PES D) (nm) | | | | | |
| Coloring agent particle dispersion | 1 | 1 | 1 | 1 | 1 |
| Release agent particle dispersion | 1 | 1 | 1 | 1 | 1 |
| Toner manufacturing | Emulsion | Emulsion | Emulsion | Emulsion | Emulsion |
| method | aggregation | aggregation | aggregation | aggregation | aggregation |
| Parts of PES A | 89 | 89 | 72 | 72 | 89 |
| Parts of resin B | 1 | 1 | 18 | 18 | 1 |
| Parts of St-Ac resin C | 0 | 0 | 0 | 0 | 0 |
| Parts of C-PES D | 10 | 10 | 10 | 10 | 10 |
| Content proportion of PES A in | 89 | 89 | 72 | 72 | 89 |
| binder resin (mass %) | | | | | |
| Presence or absence of shell | Present | Present | Present | Present | Present |
| Weight-average particle diameter | 7.0 | 6.8 | 6.8 | 6.8 | 6.8 |
| of toner particle (μm) | | | | | |
| Al element content proportion | 0.043 | 0.039 | 0.146 | 0.146 | 0.015 |
| of toner particle (mass %) | | | | | |
| Average circularity of | 0.957 | 0.963 | 0.957 | 0.957 | 0.962 |
| toner particle | | | | | |
| Peak ratio I_{S}/I_{A} | 0.02 | 0.01 | 0.2 | 0.24 | 0 |
| in ATR-IR | | | | | |

| Toner particle No. | 12 | 13 | 14 | 15 | 16 |
|---|---|---|---|---|---|
| PES A | A-6 | A-7 | A-8 | A-9 | A-10 |
| Volume-average particle diameter of resin | 120 | 130 | 120 | 120 | 130 |
| particle (PES A) (nm) | | | | | |
| Resin B | B-3 | B-1 | B-1 | B-1 | B-1 |
| Volume-average particle diameter of resin | 40 | 40 | 40 | 40 | 40 |
| particle(Resin B) (nm) | | | | | |
| St-Ac resin C | — | — | — | — | — |
| Volume-average particle diameter of resin | — | — | — | — | — |
| particle (St-Ap resin C) (nm) | | | | | |
| Crystalline Polyester D | D-1 | D-1 | D-1 | D-1 | D-1 |
| Volume-average particle diameter of resin | 150 | 150 | 150 | 150 | 150 |
| particle (C-PES D) (nm) | | | | | |
| Coloring agent particle dispersion | 1 | 1 | 1 | 1 | 1 |
| Release agent particle dispersion | 1 | 1 | 1 | 1 | 1 |
| Toner manufacturing | Emulsion | Emulsion | Emulsion | Emulsion | Emulsion |
| method | aggregating | aggregating | aggregating | aggregating | aggregating |
| Parts of PES A | 89.5 | 88 | 88 | 88 | 88 |
| Parts of resin B | 0.5 | 2 | 2 | 2 | 2 |
| Parts of St-Ac resin C | 0 | 0 | 0 | 0 | 0 |
| Parts of C-PES D | 10 | 10 | 10 | 10 | 10 |
| PES A content proportion | 89.5 | 88 | 88 | 88 | 88 |
| in binder resin (mass %) | | | | | |
| Presence or absence of shell | Present | Present | Present | Present | Present |
| Weight-average particle diameter of | 6.8 | 6.9 | 6.8 | 6.8 | 6.8 |
| toner particle (μm) | | | | | |
| Al element content proportion of | 0.012 | 0.028 | 0.034 | 0.045 | 0.043 |
| toner particle (mass %) | | | | | |
| Average circularity of toner particle | 0.958 | 0.957 | 0.957 | 0.957 | 0.957 |
| Peak ratio I_{S}/I_{A} | 0 | 0.05 | 0.05 | 0.05 | 0.05 |
| in ATR-IR | | | | | |

| Toner particle No. | 17 | 18 | 19 | 20 | 21 |
|---|---|---|---|---|---|
| PES A | A-11 | A-12 | A-5 | A-5 | A-5 |
| Volume-average particle diameter of resin | 120 | 130 | 140 | 140 | 140 |
| particle (PES A) (nm) | | | | | |
| Resin B | B-1 | B-1 | B-1 | B-1 | B-1 |
| Volume-average particle diameter of resin | 40 | 40 | 40 | 40 | 40 |
| particle(Resin B) (nm) | | | | | |
| St-Ac resin C | — | — | — | — | — |
| Volume-average particle diameter of resin | — | — | — | — | — |
| particle (St-Ap resin C) (nm) | | | | | |
| Crystalline Polyester D | D-1 | D-1 | D-1 | D-1 | D-1 |
| Volume-average particle diameter of resin | 150 | 150 | 150 | 150 | 150 |
| particle (C-PES D) (nm) | | | | | |
| Coloring agent particle dispersion | 1 | 1 | 1 | 1 | 1 |
| Release agent particle dispersion | 1 | 1 | 1 | 1 | 1 |
| Toner manufacturing | Emulsion | Emulsion | Emulsion | Emulsion | Emulsion |
| method | aggregating | aggregating | aggregating | aggregating | aggregating |
| Parts of PES A | 88 | 88 | 88 | 88 | 68 |
| Parts of resin B | 2 | 2 | 2 | 2 | 2 |
| Parts of St-Ac resin C | 0 | 0 | 0 | 0 | 0 |
| Parts of C-PES D | 10 | 10 | 10 | 10 | 30 |
| PES A content proportion | 88 | 88 | 88 | 88 | 68 |
| in binder resin (mass %) | | | | | |
| Presence or absence of shell | Present | Present | Present | Present | Present |
| Weight-average particle diameter of | 6.8 | 7.0 | 6.8 | 6.8 | 7.0 |
| toner particle (μm) | | | | | |
| Al element content proportion of | 0.045 | 0.029 | 0.039 | 0.154 | 0.029 |
| toner particle (mass %) | | | | | |
| Average circularity of toner particle | 0.963 | 0.957 | 0.958 | 0.957 | 0.948 |
| Peak ratio I_{S}/I_{A} | 0.05 | 0.05 | 0.04 | 0.04 | 0.05 |
| in ATR-IR | | | | | |

| Toner particle No. | 22 | 23 | 24 | 25 | 26 |
|---|---|---|---|---|---|
| PES A | A-5 | A-5 | A-5 | A-5 | A-5 |
| Volume-average particle diameter of | 140 | 140 | 140 | 140 | 140 |
| resin particle (PES A) (nm) | | | | | |
| Resin B | B-1 | B-1 | B-1 | B-1 | B-1 |
| Volume-average particle diameter of | 40 | 40 | 40 | 40 | 40 |
| resin particle (Resin B) (nm) | | | | | |
| St-Ac resin C | — | — | — | — | — |
| Volume-average particle diameter of | — | — | — | — | — |
| resin particle (St-Ac resin C) (nm) | | | | | |
| Crystallize Polyester D | D-1 | — | D-2 | D-3 | D-1 |
| Volume-average particle diameter of | 150 | — | 150 | 150 | 150 |
| resin particle (C-PES D) (nm) | | | | | |
| Coloring agent particle dispersion | 1 | 1 | 1 | 1 | 2 |
| Release agent particle dispersion | 1 | 1 | 1 | 1 | 2 |
| Toner manufacturing | Emulsion | Emulsion | Emulsion | Emulsion | Emulsion |
| method | aggregation | aggregation | aggregation | aggregation | aggregation |
| Parts of PES A | 95 | 98 | 88 | 88 | 88 |
| Parts of resin B | 2 | 2 | 2 | 2 | 2 |
| Parts of St-Ac resin C | 0 | 0 | 0 | 0 | 0 |
| Parts of C-PES D | 3 | 0 | 10 | 10 | 10 |
| PES A content proportion | 95 | 98 | 88 | 88 | 88 |
| in binder resin (mass %) | | | | | |
| Presence of absence of shell | Present | Present | Present | Present | Present |
| Weight-average particle diameter | 6.8 | 6.8 | 6.9 | 6.8 | 6.8 |
| of toner particle (μm) | | | | | |
| Al element content proportion of | 0.046 | 0.039 | 0.044 | 0.029 | 0.078 |
| toner particle (mass %) | | | | | |
| Average circularity of toner particle | 0.980 | 0.962 | 0.950 | 0.964 | 0.957 |
| Peak ratio I_{S}/I_{A} | 0.05 | 0.04 | 0.05 | 0.05 | 0.05 |
| in ATR-IR | | | | | |

| Toner particle No. | 27 | 28 | 29 | 30 | 31 |
|---|---|---|---|---|---|
| PES A | A-1 | A-1 | A-13 | A-14 | A-1 |
| Volume-average particle diameter of | 130 | 130 | 120 | 120 | 130 |
| resin particle (PES A) (nm) | | | | | |
| Resin B | — | B-1 | B-1 | B-1 | B-1 |
| Volume-average particle diameter of | — | 40 | 40 | 40 | — |
| resin particle (Resin B) (nm) | | | | | |
| St-Ac resin C | Present | Present | — | — | — |
| Volume-average particle diameter of | 110 | 110 | — | — | — |
| resin particle (St-Ac resin C) (nm) | | | | | |
| Crystallize Polyester D | D-1 | D-1 | D-1 | D-1 | D-1 |
| Volume-average particle diameter of | 150 | 150 | 150 | 150 | — |
| resin particle (C-PES D) (nm) | | | | | |
| Coloring agent particle dispersion | 1 | 1 | 1 | 1 | — |
| Release agent particle dispersion | 1 | 1 | 1 | 1 | — |
| Toner manufacturing | Emulsion | Emulsion | Emulsion | Emulsion | Emulsion |
| method | aggregation | aggregation | aggregation | aggregation | aggregation |
| Parts of PES A | 88 | 44 | 88 | 38 | 95 |
| Parts of resin B | 0 | 2 | 2 | 2 | 2 |
| Parts of St-Ac resin C | 2 | 44 | 0 | 0 | 0 |
| Parts of C-PES D | 10 | 10 | 10 | 10 | 3 |
| PES A content proportion | 88 | 44 | 88 | 88 | 95 |
| in binder resin (mass %) | | | | | |
| Presence of absence of shell | Present | Present | Present | Present | Absent |
| Weight-average particle diameter | 6.6 | 6.8 | 6.9 | 6.6 | 7.4 |
| of toner particle (μm) | | | | | |
| Al element content proportion of | 0.045 | 0.043 | 0.045 | 0.029 | 0 |
| toner particle (mass %) | | | | | |
| Average circularity of toner particle | 0.956 | 0.957 | 0.957 | 0.957 | 0.934 |
| Peak ratio I_{S}/I_{A} | 0 | 0.04 | 0.05 | 0.05 | 0.01 |
| in ATR-IR | | | | | |

### Examples 1 to 26 and Comparative Examples 1 to 5

The following evaluations were performed using the obtained toners. The method for evaluating each of toners 1 to 31 will be described below. The results of evaluation are shown in Table 5.

The evaluation method and evaluation criteria are as follows.

As the image-forming apparatus, a commercially available laser printer “LBP-9660Ci (manufactured by CANIN KABUSHIKI KAISHA)” that was altered such that the process speed was 325 mm/sec was used, A commercially available process cartridge (cyan) (manufactured by CANIN KABUSHIKI KAISHA) was used.

The product toners were removed from inside the cartridge, and the cartridge was cleaned by air blow and was then filled with 270 g of each toner to be evaluated. The product toners in the stations of yellow, magenta, and black were removed, and yellow, magenta, and black cartridges of which the mechanism of detecting remaining toner quantity was disabled were inserted into the respective stations and were evaluated.

### (1) Evaluation of Low-Temperature Fixability

The above-described process cartridges and modified laser printer, and LETTER size Business 4200 sheets (manufactured by XEROX Corporation, basis weight: 75 g/m²) were left in a low-temperature and low-humidity environment (15° C./10% RH) for 24 hours.

An image having a toner bearing amount of 0.40 mg/cm² and an area of 2 cm×2 cm was output on the evaluation paper. While changing fixing temperature, the fixing temperature at the time when offset occurred in the back end portion of the evaluation paper in the sheet passing direction when passed through the fixing unit was verified and evaluated.

The evaluation criteria were defined as follows:
A: no setoff at 130° C.;
B: occurrence of offset at 130° C.;
C: occurrence of offset at 140° C.;
D: occurrence of offset at 150° C.; and
E: occurrence of offset at 160° C.

### (2) Evaluation of Gloss

The above-described process cartridges and modified laser printer, and color laser copy gloss thick paper NS-701 (recording medium gloss: 70.3%, basis weight: 150 g/m², Canon Marketing Japan Inc.) were left in a normal-temperature and normal-humidity environment (23° C./50% RH) for 24 hours. After an image having a printing rate of 1.0% was output on 1,000 sheets, a solid image having a toner bearing amount of 0.40 mg/cm² was output, and image gloss (%) was measured.

The gloss was measured using a handy gloss meter PG-1M (manufactured by Nippon Denshoku Industries Co., Ltd.). In the measurement, the light projection angle and light receiving angle were both set to 60°. The gloss was measured at 20 points on the output image, and the average thereof was defined as the gloss (%).

The evaluation criteria were defined as follows:
A: the difference with recording medium gloss is less than 3%;
B: the difference with recording medium gloss is 3% or more and less than 7%;
C: the difference with recording medium gloss is 7% or more and less than 11%;
D: the difference with recording medium gloss is 11% or more and less than 15%; and
E: the difference with recording medium gloss is 15% or more.

### (3) Evaluation of Transfer Void in Vertical Thin-Line Image

The above-described process cartridges and modified laser printer, and LETTER size Business 4200 sheets (manufactured by XEROX Corporation, basis weight: 75 g/m²) were left in a normal-temperature and normal-humidity environment (23° C./50% RH), a low-temperature and low-humidity environment (15° C./10% RH), and a high-temperature and high-humidity environment (30° C./80% RH) for 24 hours each.

After an image having a printing rate of 1.0% was output on 1,000 sheets in each environment, the toner bearing amount was adjusted to 0.40 mg/cm². Two vertical lines of 2, 4, 6, 8, and 10 dots each were printed with a non-latent image width between each line of about 10 mm as an evaluation image. Furthermore, an image having a printing rate of 1.0% was output on 20,000 sheets, and then two vertical lines of 2, 4, 6, 8, and 10 dots each were similarly printed at a non-latent image width between each line of about 10 mm as an evaluation image.

The printed evaluation images were observed visually and with a 20× loupe and were evaluated based on the following criteria:
A: Voids are barely observed even by magnification observation in the 2-dot line;
B: Some voids are observed by magnification observation in the 2-dot line, and voids are barely observed by magnification observation in the 4-dot line;
C: Some voids are observed by magnification observation in the 4-dot line, and voids are not observed visually in the 2-dot line;
D: Voids are observed visually in the 2-dot line, and voids are not observed visually in the 4-dot line; and
E: Voids are observed visually in the 4-dot line.

TABLE 5

| | | | | | Transfer void | | | |
|---|---|---|---|---|---|---|---|---|
| | | | | | 1,000 | 20,000 | 1,000 | 1,000 |
| | | | | | sheets | sheets | sheets | sheets |
| | | Low- | | | Normal | Normal | Low | High |
| | | temperature | | Gloss | temperature | temperature | temperature | temperature |
| | | fixability | Gloss | unevenness | and humidity | and humidity | and humidity | and humidity |
| Example 1 | Toner 1 | A | A | A | A | A | A | A |
| Example 2 | Toner 2 | A | A | A | A | A | A | A |
| Example 3 | Toner 3 | A | A | A | B | B | A | A |
| Example 4 | Toner 4 | B | B | A | B | B | A | A |
| Example 5 | Toner 5 | C | C | D | C | C | C | C |
| Example 6 | Toner 6 | C | C | B | C | C | C | C |
| Example 7 | Toner 7 | A | A | A | A | A | A | B |
| Example 8 | Toner 8 | A | A | A | A | A | A | C |
| Example 9 | Toner 9 | A | A | A | B | B | C | C |
| Example 10 | Toner 10 | A | A | A | B | B | C | D |
| Example 11 | Toner 11 | A | A | D | B | B | C | B |
| Example 12 | Toner 12 | A | A | D | B | B | D | B |
| Example 13 | Toner 13 | A | A | A | B | B | B | B |
| Example 14 | Toner 14 | A | A | A | B | C | C | B |
| Example 15 | Toner 15 | A | A | C | B | C | C | B |
| Example 16 | Toner 16 | A | A | A | B | B | B | B |
| Example 17 | Toner 17 | A | A | A | B | B | B | B |
| Example 18 | Toner 18 | B | A | A | B | C | C | B |
| Example 19 | Toner 19 | A | A | A | B | B | C | B |
| Example 20 | Toner 20 | A | A | A | B | B | D | B |
| Example 21 | Toner 21 | A | A | A | B | C | B | B |
| Example 22 | Toner 22 | B | A | A | B | B | B | B |
| Example 23 | Toner 23 | C | A | A | B | C | B | B |
| Example 24 | Toner 24 | A | A | A | B | B | A | A |
| Example 25 | Toner 25 | B | B | A | B | B | A | A |
| Example 26 | Toner 26 | A | A | A | B | B | B | B |
| Comparative | Toner 27 | B | B | B | E | E | D | E |
| Example 1 | | | | | | | | |
| Comparative | Toner 28 | D | D | D | D | D | D | D |
| Example 2 | | | | | | | | |
| Comparative | Toner 29 | D | E | D | E | E | E | D |
| Example 3 | | | | | | | | |
| Comparative | Toner 30 | D | E | D | D | D | D | D |
| Example 4 | | | | | | | | |
| Comparative | Toner 31 | D | B | B | E | E | E | E |
| Example 5 | | | | | | | | |

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-209211 filed Dec. 2, 2024 and Japanese Patent Application No. 2023-219458 filed Dec. 26, 2023, each of which is hereby incorporated by reference herein in their entirety.

What is claimed is:

1. A toner comprising a toner particle containing a binder resin, wherein
the binder resin contains 50 mass % or more of polyester A, and the polyester A contains a unit Uᵢₛₒ derived from isophthalic acid in an amount of 60 mol % or more based on the total units derived from acid components, and
the toner particle is a core-shell particle composed of a core portion and a shell portion, and the shell portion contains resin B including a monomer unit having a functional group selected from the group consisting of a salicylate functional group and a sulfonate group.

2. The toner according to claim 1, containing 90 mol % or more of the unit Uᵢₛₒ.

3. The toner according to claim 1, wherein the polyester A contains a unit U_{EO} derived from an ethylene oxide adduct of bisphenol A and a unit U_{PO} derived from a propylene oxide adduct of bisphenol A, and the total content proportion of the unit U_{EO} and the unit U_{PO} is 90 mol % or more based on the total units derived from an alcohol component.

4. The toner according to claim 3, wherein the content proportion of the unit U_{EO} to the sum of the content proportion of the unit U_{EO} and the content proportion of the unit U_{PO} is 15 mol % or more and 40 mol % or less.

5. The toner according to claim 1, wherein in a case that number-average molecular weight (Mn) and weight-average molecular weight (Mw) of a tetrahydrofuran (THF) soluble matter of the polyester A is measured using gel permeation chromatography (GPC), the number-average molecular weight (Mn) is 3,000 or more and 10,000 or less, and a ratio (Mw/Mn) is 2.5 or more.

6. The toner according to claim 1, wherein the toner particle contains 0.015 mass % or more and 0.150 mass % or less of aluminum atoms.

7. The toner according to claim 1, wherein the binder resin contains a crystalline polyester.

8. The toner according to claim 1, wherein the toner particle has an average circularity of 0.950 or more and 0.980 or less.

9. The toner according to claim 1, wherein the resin B is a vinyl resin.

10. The toner according to claim 1, wherein ATR-IR analysis of the toner particle detects a peak intensity I_{S} derived from the salicylate functional group of the resin B and a peak intensity I_{A} derived from the carbonyl group of the polyester A, and a ratio I_{S}/I_{A} thereof is in a range of 0.02 or more and 0.20 or less.
